(19) United States
(12) Patent Application Publication
(10) Pub. No.: US 2022/0172113 A1
(43) Pub. Date: Jun. 2, 2022

(54) AUTHENTICATION PROCESSING DEVICE, AUTHENTICATION PROCESSING METHOD, TO-BE-AUTHENTICATED DEVICE, AND INFORMATION GENERATION METHOD

(71) Applicant: SONY GROUP CORPORATION, TOKYO (JP)

(72) Inventor: SHUICHI TAKAHASHI, TOKYO (JP)

(21) Appl. No.: 17/436,449

(22) PCT Filed: Dec. 13, 2019
(86) PCT No.: PCT/JP2019/048920

§ 371 Date: Sep. 3, 2021

(30) Foreign Application Priority Data
Mar. 13, 2019 (JP) 2019-045579

(51) Int. Cl. G06N 20/00; G06F 21/44; G06K 9/62

(52) U.S. Cl. CPC G06N 20/00; G06F 2221/2129; G06K 9/6256; G06F 21/44

(57) ABSTRACT

An authentication management device 20 and a to-be-authenticated device 30 share a learning model specific to the to-be-authenticated device in advance. An authentication requesting device 40 of an authentication requester transmits authentication data to the authentication management device 20 and the to-be-authenticated device 30. The authentication management device 20 inputs the authentication data to the learning model corresponding to the to-be-authenticated device 30 to generate authentication conversion data. The to-be-authenticated device 30 inputs the authentication data to the learning model and outputs to-be-authenticated side conversion data. The authentication requesting device 40 (or the authentication management device 20) can verify that the to-be-authenticated device is an authenticated device authenticated by the authentication management device when the authentication conversion data and the to-be-authenticated side conversion data are identical. Authentication accuracy can be secured simply by generating a new learning model specific to the to-be-authenticated device in case of learning model leak.

### TECHNICAL FIELD

The present technology relates to an authentication processing device, an authentication processing method, a to-be-authenticated device, and an information generation method which can, even if authentication information leaks, easily replace the authentication information to secure authentication accuracy.

### BACKGROUND ART

In conventional authentication, a password method using a password obtained by combining characters, figures, and symbols (character string) set by the person in question and the like, and a biometric method using biometric information such as the face, fingerprint, vein pattern, and iris pattern of the person in question are generally used.

In addition, in PTL 11, an image selected or created by the person in question from images found on the Internet on the basis of preference information of the person in question is set to a pass-image, and the pass-image and similar decoy images are presented at the time of authentication such that the person in question selects only the pass-image that only the person in question knows. Further, in PTL 2, a combination of images corresponding to behaviors of the person in question remembered by only the person in question is presented at the time of authentication such that the person in question selects an image consistent with a behavior history that only the person in question knows.

### CITATION LIST

### Patent Literature

[PTL 1]
JP 2013-047865 A
[PTL 2]
JP 2014-153859 A

### SUMMARY

### Technical Problem

However, in the password method, a password is generated using a complicated and long character string and an operation of regularly updating a password is necessary in order to secure security strength, and thus a user may feel encumbered or inconvenienced. In addition, in the biometric method, it is difficult to update authentication information and the influence when authentication information has leaked is considerable because biometric information of the person in question is used. Further, when a pass-image based on preferences of the person in question is used, as represented in PTL 1, authentication accuracy may deteriorate when the preferences of the person in question change or the preferences are not strong. In addition, since images and the like on the Internet are used, infringement of copyright may occur or permission for use may be difficult. Moreover, in PTL 2, authentication accuracy may deteriorate over time because the person in question needs to remember a behavior history. Furthermore, it may not be desirable to use a personal behavior history in terms of personal information protection.

Accordingly, an object of the present technology is to provide an authentication processing device, an authentication processing method, a to-be-authenticated device, and an information generation method which can easily replace authentication information even if the authentication information leaks to secure authentication accuracy.

### Solution to Problem

A first aspect of the present technology is

an authentication processing device including
an authentication unit configured to authenticate whether a to-be-authenticated device is an authenticated device on the basis of an identity of authentication conversion data obtained by inputting authentication data to a learning model specific to the authenticated device and to-be-authenticated side conversion data obtained by inputting the authentication data to a learning model of the to-be-authenticated device.

In the present technology, authentication data supplied from an authentication requesting device that acquires an authentication result of the authentication unit is input to the learning model specific to the authenticated device to generate the authentication conversion data. Further, the authentication data is input to the learning model of the to-be-authenticated device to generate the to-be-authenticated side conversion data. The authentication unit authenticates whether the to-be-authenticated device is an authenticated device on the basis of an identity of the authentication conversion data and the to-be-authenticated side conversion data and authenticates that the to-be-authenticated device is an authenticated device when the authentication conversion data and the to-be-authenticated side conversion data are identical.

The learning model specific to the authenticated device may be generated by a learning model generation unit provided in the authentication processing device or acquired from the authenticated to-be-authenticated device. Further, a provisional learning model generation unit configured to generate a provisional learning model may be provided, and the learning model generation unit may generate the learning model specific to the authenticated device by performing learning through the provisional learning model generated by the provisional learning model generation unit using learning data stored in the authenticated device. Further, a conversion processing unit may use the learning model specific to the authenticated device generated by the authenticated device by performing learning through the provisional learning model generated by the provisional learning model generation unit using the learning data stored in the authenticated device.

Further, the authentication conversion data may be disclosed, and the authentication unit may authenticate whether the to-be-authenticated device is an authenticated device on the basis of an identity of the disclosed authentication conversion data and the to-be-authenticated side conversion data. In this case, the authentication data is stored in the to-be-authenticated device.

The learning model specific to the authenticated device is generated by a learning model generation unit, and the authentication unit uses conversion data generated by inputting the authentication data stored in the authenticated device to the learning model generated by the learning model generation unit as the authentication conversion data. Further, a provisional learning model generation unit may generate a provisional learning model, and the authentication unit may generate the learning model specific to the authenticated device by performing learning through the provisional learning model generated by the provisional learning model generation unit using learning data stored in the authenticated device and use conversion data generated by inputting the authentication data stored in the authenticated device to the generated learning model as authentication conversion data to be disclosed in the authenticated device. Further, the authentication unit uses conversion data generated by the to-be-authenticated device according to an authentication instruction as the to-be-authenticated side conversion data. Further, a data storage unit configured to store learning data used to generate a learning model or a provisional learning model may be provided in the authentication processing device.

A second aspect of the present technology is

an authentication processing method including, by an authentication unit, authenticating whether a to-be-authenticated device is an authenticated device on the basis of an identity of authentication conversion data obtained by inputting authentication data to a learning model specific to the authenticated device and to-be-authenticated side conversion data obtained by inputting the authentication data to a learning model of the to-be-authenticated device.

A third aspect of the present technology is

a to-be-authenticated device including
a conversion processing unit configured to input authentication data to a learning model to generate to-be-authenticated side conversion data.

In the present technology, the conversion processing unit configured to input authentication data supplied from an authentication requesting device or authentication data stored in advance in an authentication data storage unit to the learning model to generate the to-be-authenticated side conversion data is provided. Further, when authentication conversion data is disclosed, the authentication data stored in the authentication data storage unit is input to the learning model to generate the authentication conversion data to be disclosed in a disclosure conversion processing unit. Further, the to-be-authenticated side conversion data is generated by inputting the authentication data stored in the authentication data storage unit to the learning model on the basis of a conversion data generation instruction from the outside.

The learning model may be acquired from an authentication processing device that performs authentication processing or the learning model may be generated using learning data supplied from the authentication processing device that performs authentication processing or learning data stored in advance. Further, the learning model may be generated by performing learning through a provisional learning model generated by the authentication processing device that performs authentication processing using learning data stored in advance.

A fourth aspect of the present technology is

an information generation method including, by a conversion processing unit, inputting authentication data to a learning model to generate to-be-authenticated side conversion data.

### BRIEF DESCRIPTION OF DRAWINGS

FIG. 1 is a diagram for describing the concept of a first embodiment.

FIG. 2 is a diagram illustrating a configuration of a first example of the first embodiment.

FIG. 3 is a diagram illustrating a configuration of a second example of the first embodiment.

FIG. 4 is a diagram illustrating a configuration of a third example of the first embodiment.

FIG. 5 is a diagram illustrating a configuration of a fourth example of the first embodiment.

FIG. 6 is a diagram illustrating a configuration of a fifth example of the first embodiment.

FIG. 7 is a diagram illustrating a configuration of a sixth example of the first embodiment.

FIG. 8 is a diagram illustrating a configuration of a seventh example of the first embodiment.

FIG. 9 is a diagram illustrating a configuration of an eighth example of the first embodiment.

FIG. 10 is a diagram illustrating a configuration of a ninth example of the first embodiment.

FIG. 11 is a diagram illustrating a configuration of a tenth example of the first embodiment.

FIG. 12 is a diagram illustrating a configuration of an eleventh example of the first embodiment.

FIG. 13 is a diagram illustrating a configuration of a twelfth example of the first embodiment.

FIG. 14 is a diagram for describing the concept of a modified example of the first embodiment.

FIG. 15 is a flowchart illustrating an authentication operation of the first embodiment.

FIG. 16 is a flowchart illustrating another authentication operation of the first embodiment.

FIG. 17 is a diagram for describing the concept of a second embodiment.

FIG. 18 is a diagram illustrating a configuration of a first example of the second embodiment.

FIG. 19 is a diagram illustrating a configuration of a second example of the second embodiment.

FIG. 20 is a diagram illustrating a configuration of a third example of the second embodiment.

FIG. 21 is a diagram illustrating a configuration of a fourth example of the second embodiment.

FIG. 22 is a diagram illustrating a configuration of a fifth example of the second embodiment.

FIG. 23 is a diagram illustrating a configuration of a sixth example of the second embodiment.

FIG. 24 is a diagram illustrating a configuration of a seventh example of the second embodiment.

FIG. 25 is a diagram illustrating a configuration of an eighth example of the second embodiment.

FIG. 26 is a flowchart illustrating an operation of disclosing conversion data.

FIG. 27 is a flowchart illustrating an authentication operation using authentication conversion data.

FIG. 28 is a flowchart illustrating another operation of disclosing conversion data.

### DESCRIPTION OF EMBODIMENTS

Hereinafter, modes for carrying out the present technology will be described. The description will be made in the following order.

1. With respect to present technology

### 2. First Embodiment

2-1. First example of first embodiment
2-2. Second example of first embodiment
2-3. Third example of first embodiment
2-4. Fourth example of first embodiment
2-5. Fifth example of first embodiment
2-6. Sixth example of first embodiment
2-7. Seventh example of first embodiment
2-8. Eighth example of first embodiment
2-9. Ninth example of first embodiment
2-10. Tenth example of first embodiment
2-11. Eleventh example of first embodiment
2-12. Twelfth example of first embodiment
2-13. Modified example of first embodiment
2-14. With respect to case in which to-be-authenticated device has not been authenticated
2-15. Operation example of first embodiment
2-16. Another operation example of first embodiment

### 3. Second Embodiment

3-1. First example of second embodiment
3-2. Second example of second embodiment
3-3. Third example of second embodiment
3-4. Fourth example of second embodiment
3-5. Fifth example of second embodiment
3-6. Sixth example of second embodiment
3-7. Seventh example of second embodiment
3-8. Eighth example of second embodiment
3-9. With respect to case in which to-be-authenticated device has not been
authenticated
3-10. Operation example of second embodiment
3-11. Another operation example of second embodiment
4. Other embodiments

### 1. With Respect to Present Technology

In the present technology, it is authenticated whether a to-be-authenticated device is an authenticated device on the basis of an identity of authentication conversion data obtained by inputting authentication data to a learning model specific to an authenticated device and to-be-authenticated side conversion data obtained by inputting the authentication data to a learning model of a to-be-authenticated device using deep learning through which output results from input data and input data from output results cannot be predicted.

### 2. First Embodiment

In a first embodiment, it is authenticated whether a to-be-authenticated device is an authenticated device on the basis of an identity of authentication conversion data obtained by inputting authentication data supplied from an authentication requesting device to a learning model specific to an authenticated device and to-be-authenticated side conversion data obtained by inputting the authentication data supplied from the authentication requesting device to a learning model of a to-be-authenticated device.

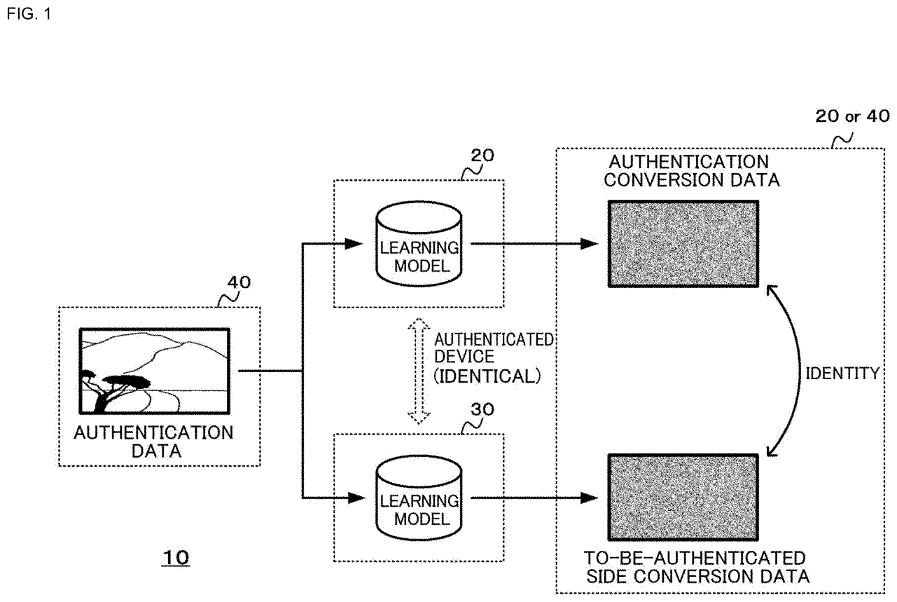

FIG. 1 is a diagram for describing the concept of the first embodiment. A technology of the first embodiment is used when, in a case in which a device of a to-be-authenticated person (to-be-authenticated device) and a device of an authentication requester (authentication requesting device) communicate with each other, the authentication requesting device wants to confirm that the to-be-authenticated device has been authenticated or wants to prove that the to-be-authenticated device has been authenticated.

In FIG. 1, an authentication management device and a to-be-authenticated device have shared the same learning model in advance. This learning model is individually generated for each authenticated device, and learning models shown in FIG. 1 are dedicated for authenticated devices. To check that the to-be-authenticated device has been authenticated, an authentication requesting device transmits authentication data (e.g., one-time original image) to the authentication management device and the to-be-authenticated device. This authentication data can be freely designated by the authentication requesting device as long as it satisfies predetermined specifications. The authentication management device inputs the authentication data to a learning model specific to an authenticated device corresponding to the to-be-authenticated device and outputs authentication conversion data that is an inference result. The to-be-authenticated device inputs the authentication data to a learning model and outputs to-be-authenticated side conversion data that is an inference result. The authentication requesting device determines that the to-be-authenticated device is an authenticated device that has been authenticated by the authentication management device on the basis of a result of comparison between the authentication conversion data and the to-be-authenticated side conversion data. That is, when the authentication conversion data and the to-be-authenticated side conversion data are identical, it is possible to prove that the learning model used by the to-be-authenticated device and the learning model used by the authentication management device are identical, and thus the authentication requesting device can verify that the to-be-authenticated device is the authenticated device that has been authenticated by the authentication management device. Accordingly, in the first embodiment, it is possible to secure authentication accuracy without a need for a user himself/herself to remember something, and even if authentication information leaks, to perform authentication by easily replacing the authentication information. Further, the authentication management device may determine whether the authentication conversion data and the to-be-authenticated side conversion data are identical and the authentication requesting device may acquire a result of verification of the to-be-authenticated device from the authentication management device. In addition, since authentication is not performed by a person, an image need not have a meaning in appearance and a noise pattern may be used as shown in FIG. 1. That is, as long as a complete identity in a pixel level unit and a gradation level unit can be verified, apparent picture quality and meaning are not important. Next, examples of the first embodiment in a case in which a to-be-authenticated device is an authenticated device will be described. In addition, a case in which a to-be-authenticated device is a device that has not been authenticated will be described thereafter. Further, in the first embodiment, an authentication processing device of the present technology corresponds to an authentication management device, an authentication requesting device, or an authentication management device and an authentication requesting device.

<2-1. First Example of First Embodiment>

In a first example of the first embodiment, a learning model is generated by the authentication management device and shared by the authentication management device and a to-be-authenticated device. In addition, the authentication requesting device outputs authentication data to the authentication management device and the to-be-authenticated device and determines whether authentication conversion data generated by the authentication management device and to-be-authenticated side conversion data generated by the to-be-authenticated device are identical.

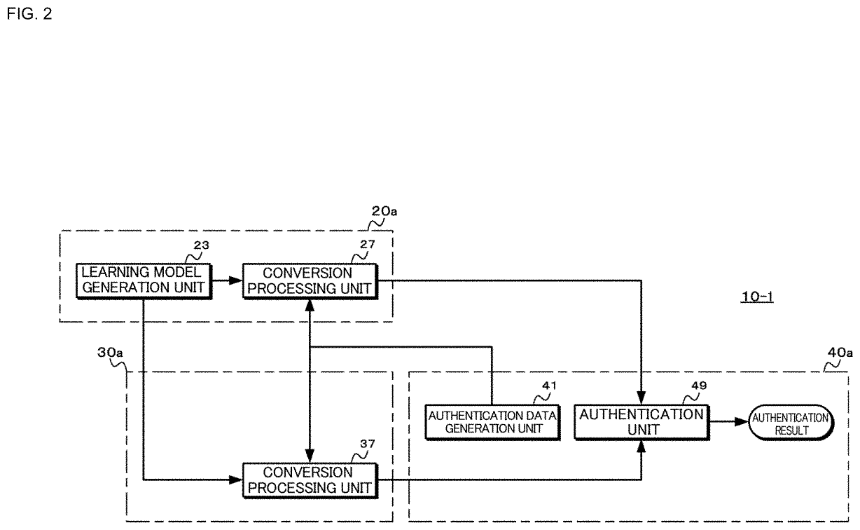

FIG. 2 illustrates a configuration of the first example of the first embodiment. An authentication system 10-1 is configured using an authentication management device 20a, a to-be-authenticated device 30a, and an authentication requesting device 40a.

The authentication management device 20a includes a learning model generation unit 23 and a conversion processing unit 27.

The learning model generation unit 23 generates a learning model. The learning model is not particularly limited as long as it has a sufficiently high degree of freedom (dimensions) of results obtained by learning a large amount of data. An object of the present technology is authentication, and it need only be guaranteed that a result obtained through conversion processing has been output from a specific learning model, and the output result need not represent an understandable specific meaning, for example. For example, a convolutional neural network (CNN) may be used as the learning model, and a learning model such as ResNet or GoogleNet may be used. The learning model generation unit 23 generates a learning model specific to each authenticated device using learning data of any of the inside and outside of the authentication management device 20a or both thereof. The learning model generation unit 23 outputs the generated learning model to the conversion processing unit 27 and the to-be-authenticated device 30a to be authenticated as an authenticated device. Further, if a plurality of pieces of data from different sources are combined and used as the learning data, it is difficult to ascertain which data has been used to generate the learning model and thus security strength can be improved.

The conversion processing unit 27 generates authentication conversion data. The conversion processing unit 27 inputs authentication data supplied from the authentication requesting device 40a to the learning model generated by the learning model generation unit 23 to generate authentication conversion data that is an inference result. The authentication conversion data generated by the conversion processing unit 27 is output to the authentication requesting device 40a.

The to-be-authenticated device 30a includes a conversion processing unit 37. The conversion processing unit 37 generates to-be-authenticated side conversion data. The conversion processing unit 37 inputs the authentication data supplied from the authentication requesting device 40a to a learning model supplied from the authentication management device 20a to generate the to-be-authenticated side conversion data that is an inference result. The conversion processing unit 37 outputs the generated to-be-authenticated side conversion data to the authentication requesting device 40a.

The authentication requesting device 40a includes an authentication data generation unit 41 and an authentication unit 49. The authentication data generation unit 41 generates authentication data used for authentication and outputs the authentication data to the conversion processing unit 27 of the authentication management device 20a and the conversion processing unit 37 of the to-be-authenticated device 30a. Authentication data is data designated by an authentication requester and can be freely designated as long as it satisfies predetermined specifications. For example, when authentication data used for authentication is images, authentication accuracy can be enhanced because a degree of freedom (dimension) of conversion data obtained by an authentication conversion data generation unit can be improved by increasing the size, bit depth, and number of images.

The authentication unit 49 authenticates that the to-be-authenticated device 30a is an authenticated device on the basis of an identity of the authentication conversion data supplied from the conversion processing unit 27 of the authentication management device 20a and the to-be-authenticated side conversion data supplied from the conversion processing unit 37 of the to-be-authenticated device 30a. Here, when the to-be-authenticated device 30a is an authenticated device, the learning model and the authentication data used in the conversion processing unit 37 and the learning model and the authentication data used in the conversion processing unit 27 are identical. Accordingly, when the authentication conversion data and the to-be-authenticated side conversion data are identical, the authentication unit 49 generates an authentication result representing that the to-be-authenticated device 30a is an authenticated device.

<2-2. Second Example of First Embodiment>

A second example of the first embodiment differs from the first example in that an authentication requesting device determines whether authentication conversion data and to-be-authenticated side conversion data are identical.

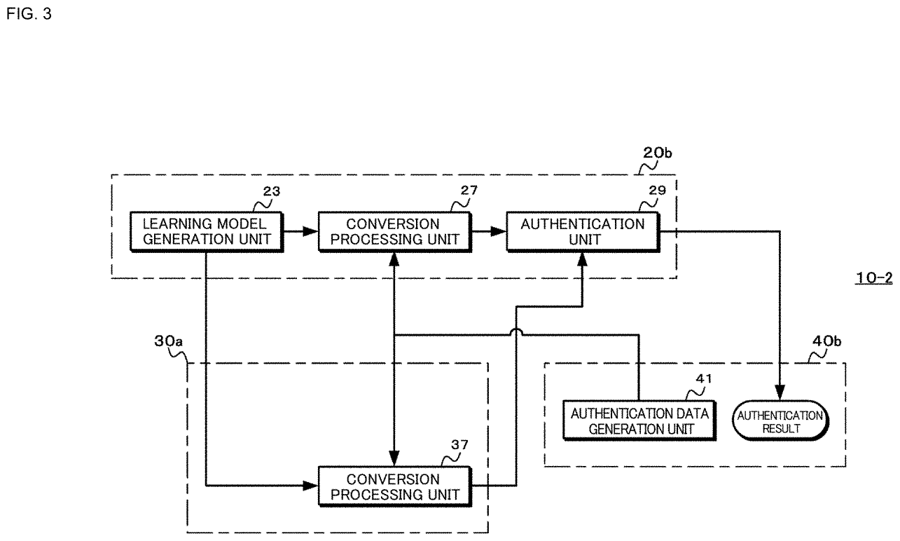

FIG. 3 illustrates a configuration of the second example of the first embodiment. An authentication system 10-2 is configured using an authentication management device 20b, the to-be-authenticated device 30a, and an authentication requesting device 40b.

The authentication management device 20b includes the learning model generation unit 23 and the conversion processing unit 27 as in the first example. In addition, the authentication management device 20b is provided with an authentication unit 29.

The learning model generation unit 23 generates a learning model and outputs the learning model to the conversion processing unit 27 and the to-be-authenticated device 30a. The conversion processing unit 27 inputs authentication data supplied from the authentication requesting device 40b to the learning model generated by the learning model generation unit 23 to generate authentication conversion data. The conversion processing unit 27 outputs the generated authentication conversion data to the authentication unit 29.

The to-be-authenticated device 30a includes the conversion processing unit 37. The conversion processing unit 37 inputs the authentication data supplied from the authentication requesting device 40b to a learning model supplied from the authentication management device 20b to generate to-be-authenticated side conversion data. The conversion processing unit 37 outputs the generated to-be-authenticated side conversion data to the authentication unit 29 of the authentication management device 20b.

The authentication requesting device 40b includes the authentication data generation unit 41. The authentication data generation unit 41 generates authentication data used for authentication and outputs the authentication data to the conversion processing unit 27 of the authentication management device 20b and the conversion processing unit 37 of the to-be-authenticated device 30a.

The authentication unit 29 of the authentication management device 20b authenticates that the to-be-authenticated device 30a is an authenticated device on the basis of an identity of the authentication conversion data supplied from the conversion processing unit 27 and the to-be-authenticated side conversion data supplied from the conversion processing unit 37 of the to-be-authenticated device 30a. As described above, when the to-be-authenticated device 30a is an authenticated device, the learning model and the authentication data used in the conversion processing unit 37 and the learning model and the authentication data used in the conversion processing unit 27 are identical. Accordingly, when the authentication conversion data and the to-be-authenticated side conversion data are identical, the authentication unit 29 generates an authentication result representing that the to-be-authenticated device 30a is an authenticated device. The authentication unit 29 outputs the authentication result to the authentication requesting device 40b.

<2-3. Third Example of First Embodiment>

A third example of the first embodiment differs from the second example in that a learning model is generated using learning data stored in an authentication management device.

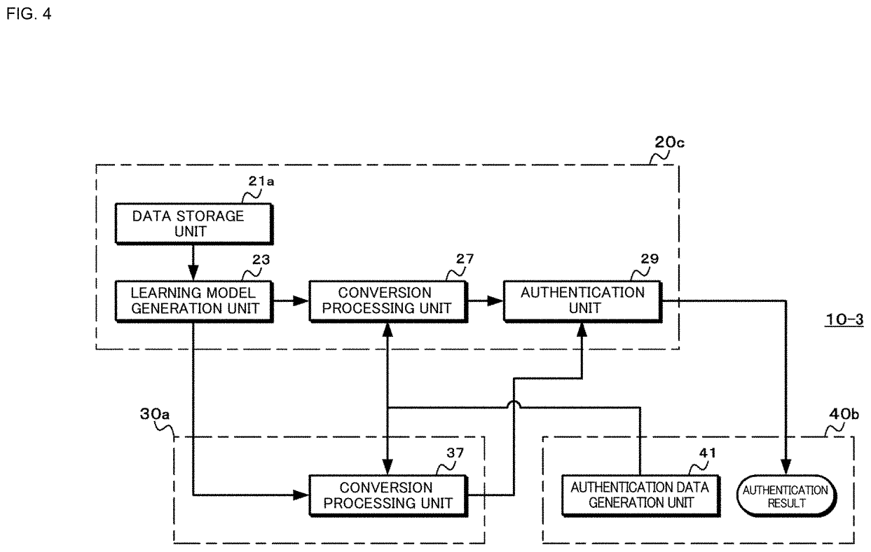

FIG. 4 illustrates a configuration of the third example of the first embodiment. An authentication system 10-3 is configured using an authentication management device 20c, the to-be-authenticated device 30a, and the authentication requesting device 40b.

The authentication management device 20c includes the learning model generation unit 23, the conversion processing unit 27, and the authentication unit 29 as in the second example. In addition, the authentication management device 20c is provided with a data storage unit 21.

The data storage unit 21 stores a large amount of learning data used to generate a learning model. The learning model generation unit 23 generates a learning model using the learning data stored in the data storage unit 21 and outputs the learning model to the conversion processing unit 27 and the to-be-authenticated device 30a. In addition, if a plurality of data groups are stored in the data storage unit 21 and pieces of learning data from the plurality of data groups are combined and used, security strength can be improved because it is difficult to ascertain which data has been used to generate the learning model.

The conversion processing unit 27 inputs authentication data supplied from the authentication requesting device 40b to the learning model generated by the learning model generation unit 23 to generate authentication conversion data. The conversion processing unit 27 outputs the generated authentication conversion data to the authentication unit 29.

The authentication unit 29 authenticates whether the to-be-authenticated device 30a is an authenticated device on the basis of an identity of the authentication conversion data supplied from the conversion processing unit 27 and the to-be-authenticated side conversion data supplied from the conversion processing unit 37 of the to-be-authenticated device 30a. When the authentication conversion data and the to-be-authenticated side conversion data are identical, the authentication unit 29 generates an authentication result representing that the to-be-authenticated device 30a is an authenticated device and outputs the authentication result to the authentication requesting device 40b.

The to-be-authenticated device 30a includes the conversion processing unit 37. The conversion processing unit 37 inputs the authentication data supplied from the authentication requesting device 40b to a learning model supplied from the authentication management device 20c to generate to-be-authenticated side conversion data. The conversion processing unit 37 outputs the generated to-be-authenticated side conversion data to the authentication unit 29 of the authentication management device 20c.

The authentication requesting device 40b includes the authentication data generation unit 41. The authentication data generation unit 41 generates authentication data used for authentication and outputs the authentication data to the conversion processing unit 27 of the authentication management device 20c and the conversion processing unit 37 of the to-be-authenticated device 30a.

<2-4. Fourth Example of First Embodiment>

A fourth example of the first embodiment represents a case in which a learning model is generated in a to-be-authenticated device.

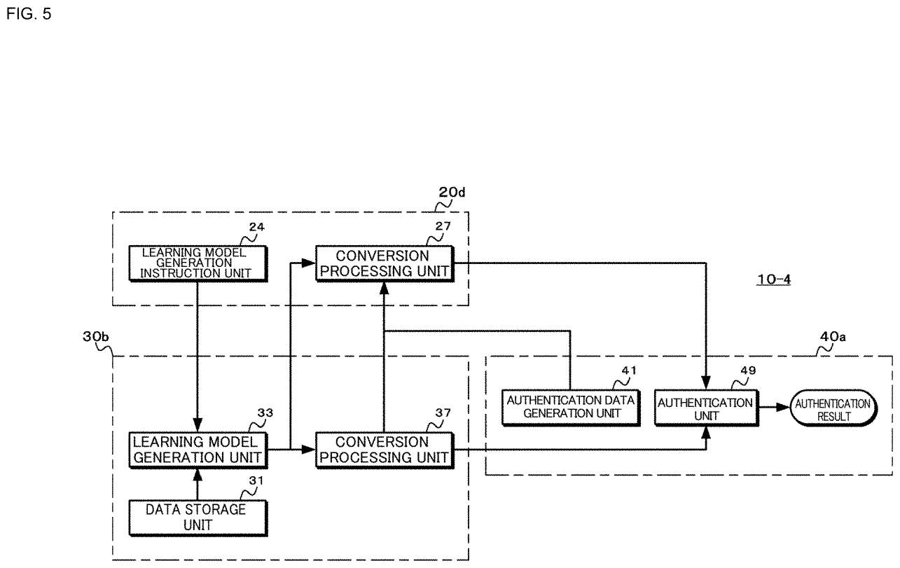

FIG. 5 illustrates a configuration of the fourth example of the first embodiment. An authentication system 10-4 is configured using an authentication management device 20d, a to-be-authenticated device 30b, and the authentication requesting device 40a.

The authentication management device 20d includes a learning model generation instruction unit 24 and the conversion processing unit 27.

The learning model generation instruction unit 24 instructs the to-be-authenticated device 30b to generate a learning model.

The conversion processing unit 27 inputs authentication data from the authentication requesting device 40a to the learning model generated by the to-be-authenticated device 30b to generate authentication conversion data. The conversion processing unit 27 outputs the generated authentication conversion data to the authentication unit 49 of the authentication requesting device 40a.

The to-be-authenticated device 30b includes a data storage unit 31, a learning model generation unit 33, and the conversion processing unit 37.

The data storage unit 31 stores learning data used to generate a learning model. The learning model generation unit 33 generates a learning model using the learning data stored in the data storage unit 31 and outputs the learning model to the conversion processing unit 37 and the conversion processing unit 37 of the authentication management device 20d.

The conversion processing unit 37 inputs the authentication data supplied from the authentication requesting device 40a to the learning model generated by the learning model generation unit 33 to generate to-be-authenticated side conversion data. The conversion processing unit 37 outputs the generated to-be-authenticated side conversion data to the authentication unit 49 of the authentication requesting device 40a.

The authentication requesting device 40a includes the authentication data generation unit 41 and the authentication unit 49. The authentication data generation unit 41 generates authentication data used for authentication and outputs the authentication data to the conversion processing unit 27 of the authentication management device 20d and the conversion processing unit 37 of the to-be-authenticated device 30b.

The authentication unit 49 authenticates whether the to-be-authenticated device 30b is an authenticated device on the basis of an identity of the authentication conversion data supplied from the conversion processing unit 27 of the authentication management device 20d and the to-be-authenticated side conversion data supplied from the conversion processing unit 37 of the to-be-authenticated device 30b. When the authentication conversion data and the to-be-authenticated side conversion data are identical, the authentication unit 29 generates an authentication result representing that the to-be-authenticated device 30b is an authenticated device.

<2-5. Fifth Example of First Embodiment>

A fifth example of the first embodiment differs from the fourth example in that an authentication requesting device determines an identity of authentication conversion data and to-be-authenticated side conversion data.

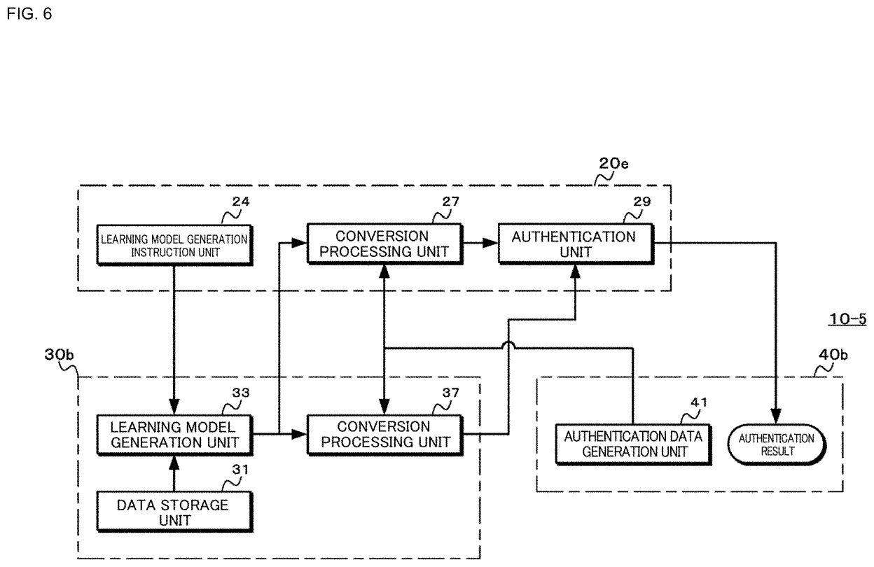

FIG. 6 illustrates a configuration of the fifth example of the first embodiment. An authentication system 10-5 is configured using an authentication management device 20e, the to-be-authenticated device 30b, and the authentication requesting device 40b.

The authentication management device 20e includes the learning model generation instruction unit 24, the conversion processing unit 27, and the authentication unit

The learning model generation instruction unit 24 instructs the to-be-authenticated device 30b to generate a learning model.

The conversion processing unit 27 inputs authentication data from the authentication requesting device 40b to the learning model generated by the to-be-authenticated device 30b to generate authentication conversion data. The conversion processing unit 27 outputs the generated authentication conversion data to the authentication unit 29.

The authentication unit 29 authenticates whether the to-be-authenticated device 30b is an authenticated device on the basis of an identity of the authentication conversion data supplied from the conversion processing unit 27 and the to-be-authenticated side conversion data supplied from the conversion processing unit 37 of the to-be-authenticated device 30b. When the authentication conversion data and the to-be-authenticated side conversion data are identical, the authentication unit 29 generates an authentication result representing that the to-be-authenticated device 30b is an authenticated device and outputs the authentication result to the authentication requesting device 40b.

The to-be-authenticated device 30b includes the data storage unit 31, the learning model generation unit 33, and the conversion processing unit 37.

The data storage unit 31 stores learning data used to generate a learning model. The learning model generation unit 33 generates a learning model using the learning data stored in the data storage unit 31 on the basis of an instruction from the learning model generation instruction unit 24 of the authentication management device 20e and outputs the learning model to the conversion processing unit 37 and the conversion processing unit 27 of the authentication management device 20e.

The conversion processing unit 37 inputs the authentication data supplied from the authentication requesting device 40b to the learning model generated by the learning model generation unit 33 to generate to-be-authenticated side conversion data. The conversion processing unit 37 outputs the generated to-be-authenticated side conversion data to the authentication unit 29 of the authentication management device 20e.

The authentication requesting device 40b includes the authentication data generation unit 41. The authentication data generation unit 41 generates authentication data used for authentication and outputs the authentication data to the conversion processing unit 27 of the authentication management device 20e and the conversion processing unit 37 of the to-be-authenticated device 30b.

<2-6. Sixth Example of First Embodiment>

A sixth example of the first embodiment differs from the fifth example in that learning data for generating a learning model is supplied from an authentication management device to a to-be-authenticated device.

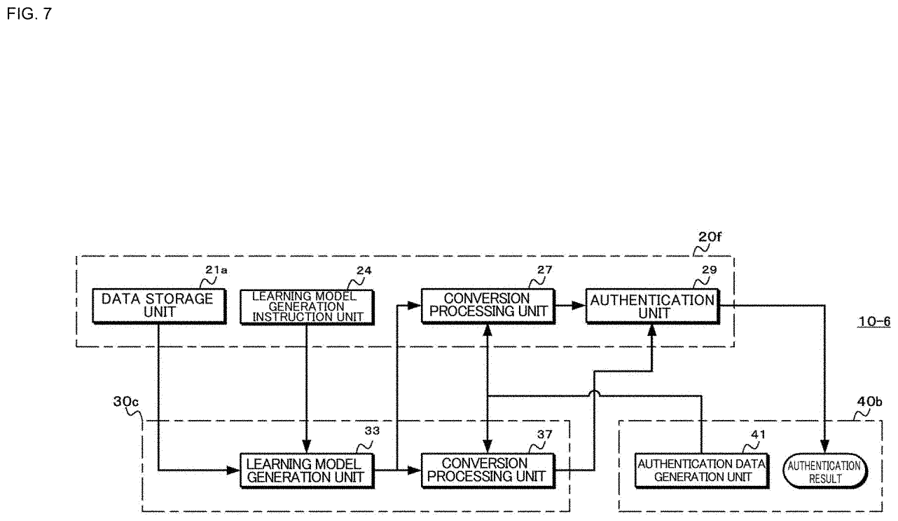

FIG. 7 illustrates a configuration of the sixth example of the first embodiment. An authentication system 10-6 is configured using an authentication management device 20f, a to-be-authenticated device 30c and the authentication requesting device 40b.

The authentication management device 20f includes a data storage unit 21, the learning model generation instruction unit 24, the conversion processing unit 27, and the authentication unit 29.

The data storage unit 21 stores learning data used to generate a learning model. The data storage unit 21 selects learning data for generating a learning model specific to the to-be-authenticated device 30c assumed to be an authenticated device from the stored learning data and outputs the selected learning data to the learning model generation unit 33 of the to-be-authenticated device 30c. As learning data, data managed and held outside the authentication management device and data held by the to-be-authenticated device itself may be used, and data obtained by combining all the data may also be used.

The learning model generation instruction unit 24 instructs the to-be-authenticated device 30c to generate a learning model.

The conversion processing unit 27 inputs authentication data from the authentication requesting device 40b to the learning model generated by the to-be-authenticated device 30c to generate authentication conversion data. The conversion processing unit 27 outputs the generated authentication conversion data to the authentication unit 29.

The authentication unit 29 authenticates whether the to-be-authenticated device 30c is an authenticated device on the basis of an identity of the authentication conversion data supplied from the conversion processing unit 27 and the to-be-authenticated side conversion data supplied from the conversion processing unit 37 of the to-be-authenticated device 30c. When the authentication conversion data and the to-be-authenticated side conversion data are identical, the authentication unit 29 generates an authentication result representing that the to-be-authenticated device 30c is an authenticated device and outputs the authentication result to the authentication requesting device 40b.

The to-be-authenticated device 30c includes the learning model generation unit 33 and the conversion processing unit 37.

The learning model generation unit 33 generates a learning model using learning data supplied from the data storage unit 21 of the authentication management device 20f on the basis of an instruction from the learning model generation instruction unit 24 of the authentication management device 20f and outputs the generated learning model to the conversion processing unit 37 and the conversion processing unit 27 of the authentication management device 20f. If a plurality of pieces of data from different sources are combined and used as the learning data supplied from the data storage unit 21, it is difficult to ascertain which data has been used to generate the learning model in the learning model generation unit 33 and thus security strength can be improved.

The conversion processing unit 37 inputs the authentication data supplied from the authentication requesting device 40b to the learning model generated by the learning model generation unit 33 to generate to-be-authenticated side conversion data. The conversion processing unit 37 outputs the generated to-be-authenticated side conversion data to the authentication unit 29 of the authentication management device 20f.

The authentication requesting device 40b includes the authentication data generation unit 41. The authentication data generation unit 41 generates authentication data used for authentication and outputs the authentication data to the conversion processing unit 27 of the authentication management device 20f and the conversion processing unit 37 of the to-be-authenticated device 30c.

<2-7. Seventh Example of First Embodiment>

A seventh example of the first embodiment differs from the above-described examples in that communication of a learning model is not performed between an authentication management device and a to-be-authenticated device to prevent the learning model from leaking. In addition, since generation of a learning model requires high calculation cost, generation of a learning model in the to-be-authenticated device is a considerable burden on the to-be-authenticated device. Accordingly, in the seventh example, a provisional learning model obtained by performing generation of a learning model halfway in the authentication management device is supplied to the to-be-authenticated device assumed to be an authenticated device, and additional learning (so-called transfer learning) is performed through the provisional learning model using learning data designated by the to-be-authenticated device to reduce calculation cost of the to-be-authenticated device and to generate a learning model specific to the to-be-authenticated device.

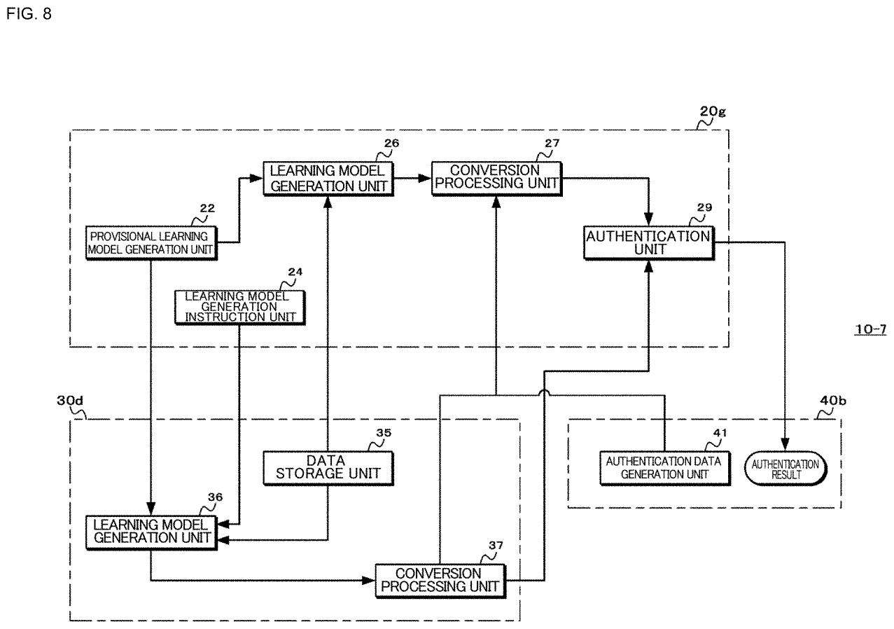

FIG. 8 illustrates a configuration of the seventh example of the first embodiment. An authentication system 10-7 is configured using an authentication management device 20g, a to-be-authenticated device 30d, and the authentication requesting device 40b.

The authentication management device 20g includes a provisional learning model generation unit 22, the learning model generation instruction unit 24, a learning model generation unit 26, the conversion processing unit 27, and the authentication unit 29.

The provisional learning model generation unit 22 generates a provisional learning model. The provisional learning model generation unit 22 generates the provisional learning model using learning data of any of the inside and outside of the authentication management device 20g or both thereof. The provisional learning model generation unit 22 outputs the generated provisional learning model to the learning model generation unit 26 and a learning model generation unit 36 of the to-be-authenticated device 30d.

The learning model generation instruction unit 24 instructs the to-be-authenticated device 30d to generate a learning model.

The learning model generation unit 26 generates a learning model specific to the to-be-authenticated device 30d, which is different from the provisional learning model, using the provisional learning model generated by the provisional learning model generation unit 22 and learning data stored in a data storage unit 35 of the to-be-authenticated device 30d on the basis of an instruction from the learning model generation instruction unit 24 of the authentication management device 20g. The learning model generation unit 26 outputs the generated learning model to the conversion processing unit 27.

The conversion processing unit 27 inputs authentication data from the authentication requesting device 40b to the learning model generated by the learning model generation unit 26 to generate authentication conversion data. The conversion processing unit 27 outputs the generated authentication conversion data to the authentication unit 29.

The authentication unit 29 authenticates whether the to-be-authenticated device 30d is an authenticated device on the basis of an identity of the authentication conversion data supplied from the conversion processing unit 27 and the to-be-authenticated side conversion data supplied from the conversion processing unit 37 of the to-be-authenticated device 30d. When the authentication conversion data and the to-be-authenticated side conversion data are identical, the authentication unit 29 generates an authentication result representing that the to-be-authenticated device 30d is an authenticated device and outputs the authentication result to the authentication requesting device 40b.

The to-be-authenticated device 30d includes the data storage unit 35, the learning model generation unit 36, and the conversion processing unit 37.

The data storage unit 35 stores learning data used to generate a learning model. Meanwhile, since the provisional learning model is generated in the authentication management device 20g, the learning data stored in the data storage unit 35 is a smaller amount of data as compared to data used to generate a learning model and may be data capable of generating a learning model specific to the to-be-authenticated device 30d, which is different from the provisional learning model. The learning data stored in the data storage unit 35 is used in the learning model generation unit 36 and the learning model generation unit 26 of the authentication management device 20g.

The learning model generation unit 36 generates a learning model specific to the to-be-authenticated device 30d, which is different from the provisional learning model, using the provisional learning model generated by the provisional learning model generation unit 22 of the authentication management device 20g and the learning data stored in the data storage unit 35. The learning model generation unit 36 outputs the generated learning model to the conversion processing unit 37.

The conversion processing unit 37 inputs authentication data from the authentication requesting device 40b to the learning model generated by the learning model generation unit 36 to generate to-be-authenticated side conversion data. The conversion processing unit 37 outputs the generated to-be-authenticated side conversion data to the authentication unit 29 of the authentication management device 20g.

The authentication requesting device 40b includes the authentication data generation unit 41. The authentication data generation unit 41 generates authentication data used for authentication and outputs the authentication data to the conversion processing unit 27 of the authentication management device 20g and the conversion processing unit 37 of the to-be-authenticated device 30d.

<2-8. Eighth Example of First Embodiment>

An eighth example of the first embodiment differs from the seventh example in that an authentication management device is provided with a data storage unit and an authentication requesting device is provided with an authentication unit.

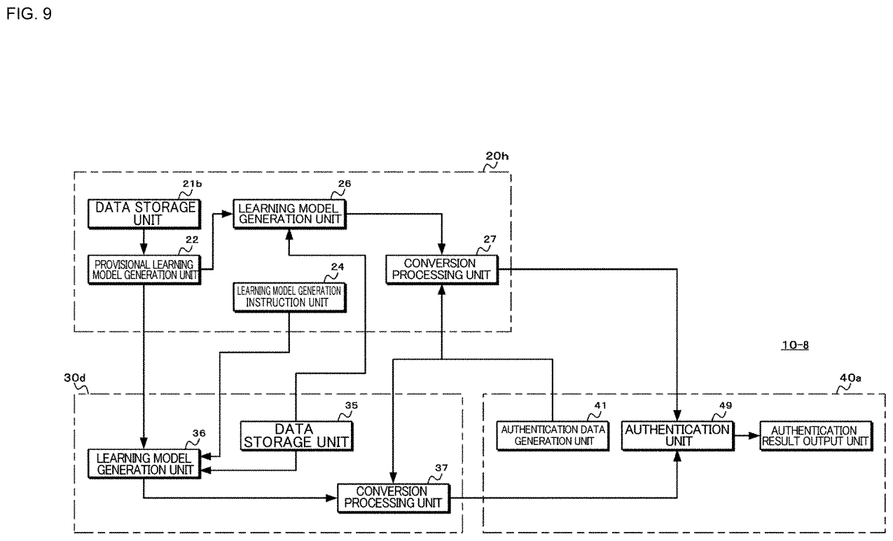

FIG. 9 illustrates a configuration of the eighth example of the first embodiment. An authentication system 10-7 is configured using an authentication management device 20h, a to-be-authenticated device 30d, and the authentication requesting device 40a.

The authentication management device 20h includes a data storage unit 21b, the provisional learning model generation unit 22, the learning model generation instruction unit 24, the learning model generation unit 26, and the conversion processing unit 27.

The data storage unit 21b stores provisional learning data used to generate a provisional learning model. The provisional learning data stored in the data storage unit 21b is used to generate a provisional learning model in the provisional learning model generation unit 22.

The provisional learning model generation unit 22 generates a provisional learning model. The provisional learning model generation unit 22 generate the provisional learning model using the provisional learning data stored in the data storage unit 21b. The provisional learning model generation unit 22 outputs the generated provisional learning model to the learning model generation unit 26 and the learning model generation unit 36 of the to-be-authenticated device 30d.

The learning model generation instruction unit 24 instructs the to-be-authenticated device 30d to generate a learning model.

The learning model generation unit 26 generate a learning model specific to the to-be-authenticated device 30d using the provisional learning model generated by the provisional learning model generation unit 22 and learning data stored in the data storage unit 35 of the to-be-authenticated device 30d. The learning model generation unit 26 outputs the generated learning model to the conversion processing unit 27.

The conversion processing unit 27 inputs authentication data from the authentication requesting device 40a to the learning model generated by the learning model generation unit 26 to generate authentication conversion data. The conversion processing unit 27 outputs the generated authentication conversion data to the authentication unit 49 of the authentication requesting device 40a.

The to-be-authenticated device 30d includes the data storage unit 35, the learning model generation unit 36, and the conversion processing unit 37.

The data storage unit 35 stores learning data used to generate a learning model, and the learning data is used in the learning model generation unit 36 and the learning model generation unit 26 of the authentication management device 20h.

The learning model generation unit 36 generates a learning model specific to the to-be-authenticated device 30d, which is different from the provisional learning model, using the provisional learning model generated by the provisional learning model generation unit 22 of the authentication management device 20h and the learning data stored in the data storage unit 35 on the basis of an instruction from the learning model generation instruction unit 24 of the authentication management device 20h. The learning model generation unit 36 outputs the generated learning model to the conversion processing unit 37.

The conversion processing unit 37 inputs authentication data from the authentication requesting device 40a to the learning model generated by the learning model generation unit 36 to generate to-be-authenticated side conversion data. The conversion processing unit 37 outputs the generated to-be-authenticated side conversion data to the authentication unit 49 of the authentication requesting device 40a.

The authentication requesting device 40a includes the authentication data generation unit 41 and the authentication unit 49. The authentication data generation unit 41 generates authentication data used for authentication and outputs the authentication data to the conversion processing unit 27 of the authentication management device 20h and the conversion processing unit 37 of the to-be-authenticated device 30d.

The authentication unit 49 authenticates whether the to-be-authenticated device 30d is an authenticated device on the basis of an identity of the authentication conversion data supplied from the conversion processing unit 27 of the authentication management device 20h and the to-be-authenticated side conversion data supplied from the conversion processing unit 37 of the to-be-authenticated device 30d. When the authentication conversion data and the to-be-authenticated side conversion data are identical, the authentication unit 29 generates an authentication result representing that the to-be-authenticated device 30d is an authenticated device.

<2-9. Ninth Example of First Embodiment>

A ninth example of the first embodiment differs from the eighth example in that an authentication management device is provided with an authentication unit.

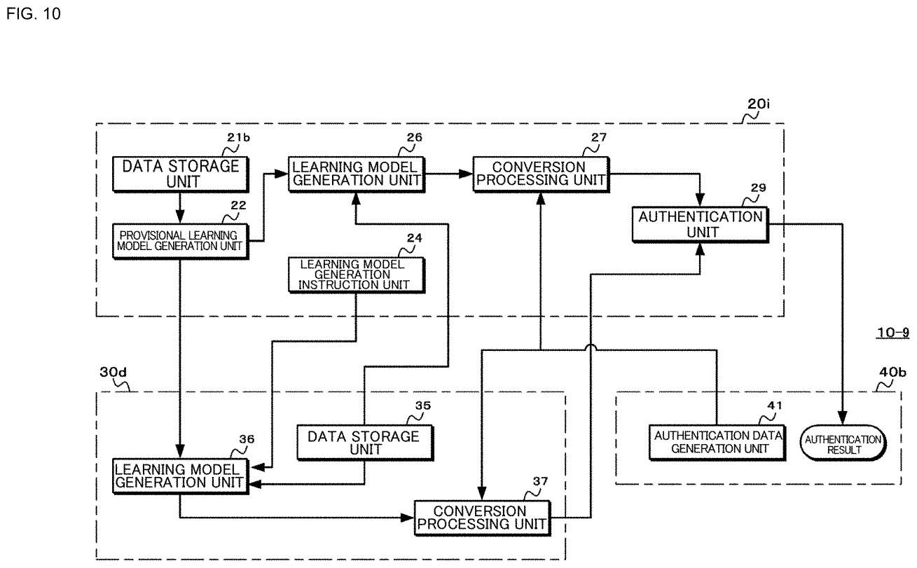

FIG. 10 illustrates a configuration of the ninth example of the first embodiment. An authentication system 10-9 is configured using an authentication management device 20i, the to-be-authenticated device 30d, and the authentication requesting device 40b.

The authentication management device 20i includes the data storage unit 21b, the provisional learning model generation unit 22, the learning model generation instruction unit 24, the learning model generation unit 26, the conversion processing unit 27, and the authentication unit 29.

The data storage unit 21b stores provisional learning data used to generate a provisional learning model. The provisional learning data stored in the data storage unit 21b is used to generate a provisional learning model in the provisional learning model generation unit 22.

The provisional learning model generation unit 22 generates a provisional learning model. The provisional learning model generation unit 22 generates the provisional learning model using the provisional learning data stored in the data storage unit 21b. The provisional learning model generation unit 22 outputs the generated provisional learning model to the learning model generation unit 26 and the learning model generation unit 36 of the to-be-authenticated device 30d.

The learning model generation instruction unit 24 instructs the to-be-authenticated device 30d to generate a learning model.

The learning model generation unit 26 generates a learning model specific to the to-be-authenticated device 30d, which is different from the provisional learning model, using the provisional learning model generated by the provisional learning model generation unit 22 and learning data stored in the data storage unit 35 of the to-be-authenticated device 30d. The learning model generation unit 26 outputs the generated learning model to the conversion processing unit 27.

The conversion processing unit 27 inputs authentication data from the authentication requesting device 40b to the learning model generated by the learning model generation unit 26 to generate authentication conversion data. The conversion processing unit 27 outputs the generated authentication conversion data to the authentication unit 29.

The authentication unit 29 authenticates whether the to-be-authenticated device 30d is an authenticated device on the basis of an identity of the authentication conversion data supplied from the conversion processing unit 27 and the to-be-authenticated side conversion data supplied from the conversion processing unit 37 of the to-be-authenticated device 30d. When the authentication conversion data and the to-be-authenticated side conversion data are identical, the authentication unit 29 generates an authentication result representing that the to-be-authenticated device 30d is an authenticated device and outputs the authentication result to the authentication requesting device 40b.

The to-be-authenticated device 30d includes the data storage unit 35, the learning model generation unit 36, and the conversion processing unit 37.

The data storage unit 35 stores learning data used to generate a learning model, and the learning data is used in the learning model generation unit 36 and the learning model generation unit 26 of the authentication management device 20i as described above.

The learning model generation unit 36 generates a learning model specific to the to-be-authenticated device 30d, which is different from the provisional learning model, using the provisional learning model generated by the provisional learning model generation unit 22 of the authentication management device 20i and the learning data stored in the data storage unit 35 on the basis of an instruction from the learning model generation instruction unit 24 of the authentication management device 20i. The learning model generation unit 36 outputs the generated learning model to the conversion processing unit 37.

The conversion processing unit 37 inputs authentication data from the authentication requesting device 40b to the learning model generated by the learning model generation unit 36 to generate to-be-authenticated side conversion data. The conversion processing unit 37 outputs the generated to-be-authenticated side conversion data to the authentication unit 29 of the authentication management device 20i.

The authentication requesting device 40b includes the authentication data generation unit 41. The authentication data generation unit 41 generates authentication data used for authentication and outputs the authentication data to the conversion processing unit 27 of the authentication management device 20i and the conversion processing unit 37 of the to-be-authenticated device 30d.

<2-10. Tenth Example of First Embodiment>

A tenth example of the first embodiment differs from the above-described examples in that a learning model specific to a to-be-authenticated device is generated in the to-be-authenticated device on the basis of a provisional learning model and the generated learning model is output from the to-be-authenticated device to an authentication management device.

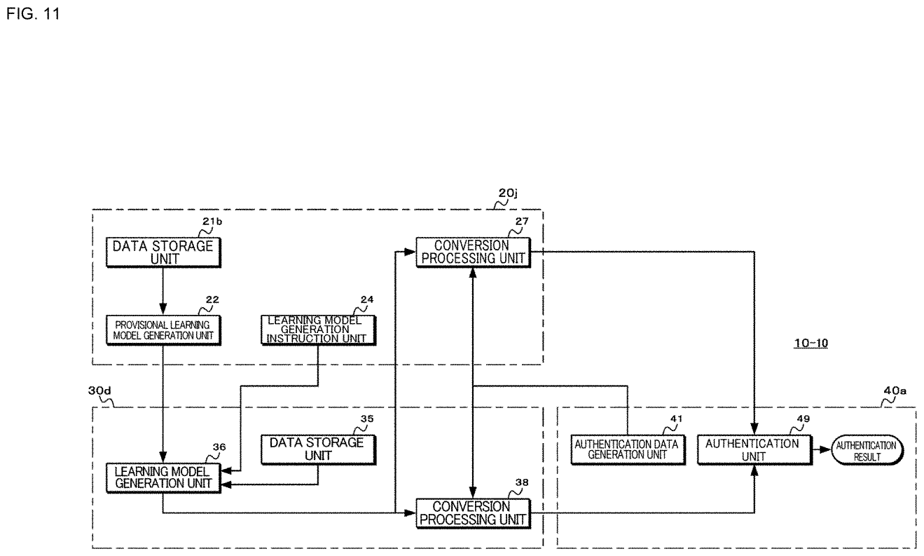

FIG. 11 illustrates a configuration of the tenth example of the first embodiment. An authentication system 10-10 is configured using an authentication management device 20j, the to-be-authenticated device 30d, and the authentication requesting device 40a.

The authentication management device 20j includes the data storage unit 21b, the provisional learning model generation unit 22, the learning model generation instruction unit 24, and the conversion processing unit 27.

The data storage unit 21b stores provisional learning data used to generate a provisional learning model. The provisional learning data stored in the data storage unit 21b is used to generate a provisional learning model in the provisional learning model generation unit 22.

The provisional learning model generation unit 22 generates a provisional learning model. The provisional learning model generation unit 22 generates the provisional learning model using the provisional learning data stored in the data storage unit 21b. The provisional learning model generation unit 22 outputs the generated provisional learning model to the learning model generation unit 36 of the to-be-authenticated device 30d.

The learning model generation instruction unit 24 instructs the to-be-authenticated device 30d to generate a learning model.

The conversion processing unit 27 acquires the learning model generated by the learning model generation unit 36 of the to-be-authenticated device 30d and inputs authentication data from the authentication requesting device 40a to this learning model to generate authentication conversion data. The conversion processing unit 27 outputs the generated authentication conversion data to the authentication unit 49 of the authentication requesting device 40a.

The to-be-authenticated device 30d includes the data storage unit 35, the learning model generation unit 36, and the conversion processing unit 37.

The data storage unit 35 stores learning data used to generate a learning model, and the learning data is used in the learning model generation unit 36.

The learning model generation unit 36 generates a learning model specific to the to-be-authenticated device 30d, which is different from the provisional learning model, using the provisional learning model generated by the provisional learning model generation unit 22 of the authentication management device 20j and the learning data stored in the data storage unit 35 on the basis of an instruction from the learning model generation instruction unit 24 of the authentication management device 20j. The learning model generation unit 36 outputs the generated learning model to the conversion processing unit 37 and the conversion processing unit 27 of the authentication management device 20j.

The conversion processing unit 37 inputs authentication data from the authentication requesting device 40a to the learning model generated by the learning model generation unit 36 to generate to-be-authenticated side conversion data. The conversion processing unit 37 outputs the generated to-be-authenticated side conversion data to the authentication unit 49 of the authentication requesting device 40a.

The authentication requesting device 40a includes the authentication data generation unit 41 and the authentication unit 49. The authentication data generation unit 41 generates authentication data used for authentication and outputs the authentication data to the conversion processing unit 27 of the authentication management device 20j and the conversion processing unit 37 of the to-be-authenticated device 30d.

The authentication unit 49 authenticates whether the to-be-authenticated device 30d is an authenticated device on the basis of an identity of the authentication conversion data supplied from the conversion processing unit 27 of the authentication management device 20j and the to-be-authenticated side conversion data supplied from the conversion processing unit 37 of the to-be-authenticated device 30d. When the authentication conversion data and the to-be-authenticated side conversion data are identical, the authentication unit 29 generates an authentication result representing that the to-be-authenticated device 30d is an authenticated device.

<2-11. Eleventh Example of First Embodiment>

An eleventh example of the first embodiment differs from the tenth example in that an authentication management device is not provided with a data storage unit and is provided with an authentication unit.

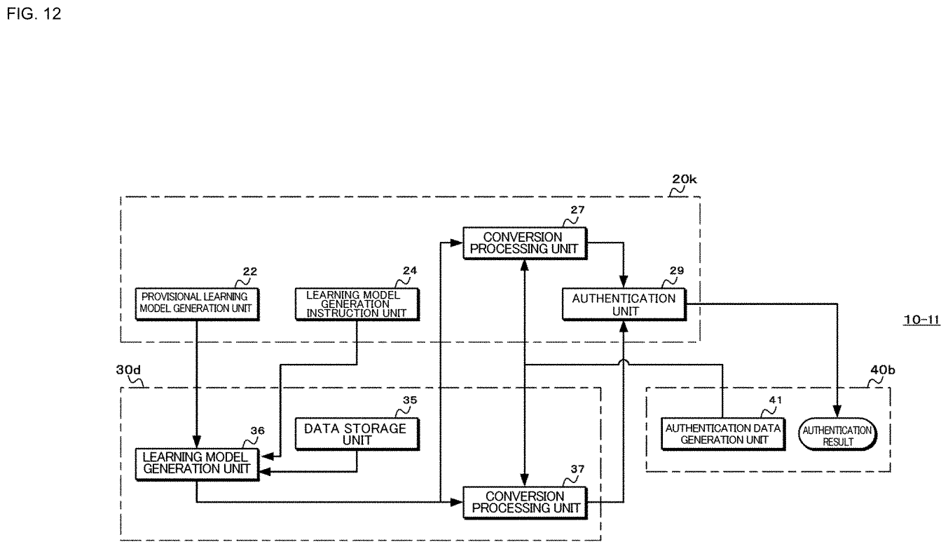

FIG. 12 illustrates a configuration of the eleventh example of the first embodiment. An authentication system 10-11 is configured using an authentication management device 20k, the to-be-authenticated device 30d, and the authentication requesting device 40b.

The authentication management device 20k includes the provisional learning model generation unit 22, the learning model generation instruction unit 24, the conversion processing unit 27, and the authentication unit 29.

The provisional learning model generation unit 22 generates a provisional learning model. The provisional learning model generation unit 22 generates the provisional learning model using learning data of any of the inside and outside of the authentication management device 20k or both thereof. The provisional learning model generation unit 22 outputs the generated provisional learning model to the learning model generation unit 26 and the learning model generation unit 36 of the to-be-authenticated device 30d.

The learning model generation instruction unit 24 instructs the to-be-authenticated device 30d to generate a learning model.

The conversion processing unit 27 acquires the learning model generated by the learning model generation unit 36 of the to-be-authenticated device 30d and inputs authentication data from the authentication requesting device 40b to this learning model to generate authentication conversion data. The conversion processing unit 27 outputs the generated authentication conversion data to the authentication unit

The authentication unit 29 authenticates whether the to-be-authenticated device 30d is an authenticated device on the basis of an identity of the authentication conversion data supplied from the conversion processing unit 27 and the to-be-authenticated side conversion data supplied from the conversion processing unit 37 of the to-be-authenticated device 30d. When the authentication conversion data and the to-be-authenticated side conversion data are identical, the authentication unit 29 generates an authentication result representing that the to-be-authenticated device 30d is an authenticated device and outputs the authentication result to the authentication requesting device 40b.

The to-be-authenticated device 30d includes the data storage unit 35, the learning model generation unit 36, and the conversion processing unit 37.

The data storage unit 35 stores learning data used to generate a learning model, and the learning data is used in the learning model generation unit 36 and the learning model generation unit 26 of the authentication management device 20k as described above.

The learning model generation unit 36 generates a learning model specific to the to-be-authenticated device 30d, which is different from the provisional learning model, using the provisional learning model generated by the provisional learning model generation unit 22 of the authentication management device 20k and the learning data stored in the data storage unit 35 on the basis of an instruction from the learning model generation instruction unit 24 of the authentication management device 20k. The learning model generation unit 36 outputs the generated learning model to the conversion processing unit 37 and the conversion processing unit 27 of the authentication management device 20k.

The conversion processing unit 37 inputs authentication data from the authentication requesting device 40b to the learning model generated by the learning model generation unit 36 to generate to-be-authenticated side conversion data. The conversion processing unit 37 outputs the generated to-be-authenticated side conversion data to the authentication unit 29 of the authentication management device 20k.

The authentication requesting device 40b includes the authentication data generation unit 41. The authentication data generation unit 41 generates authentication data used for authentication and outputs the authentication data to the conversion processing unit 27 of the authentication management device 20k and the conversion processing unit 37 of the to-be-authenticated device 30d.

<2-12. Twelfth Example of First Embodiment>

A twelfth example of the first embodiment differs from the eleventh example in that an authentication management device is provided with a data storage unit.

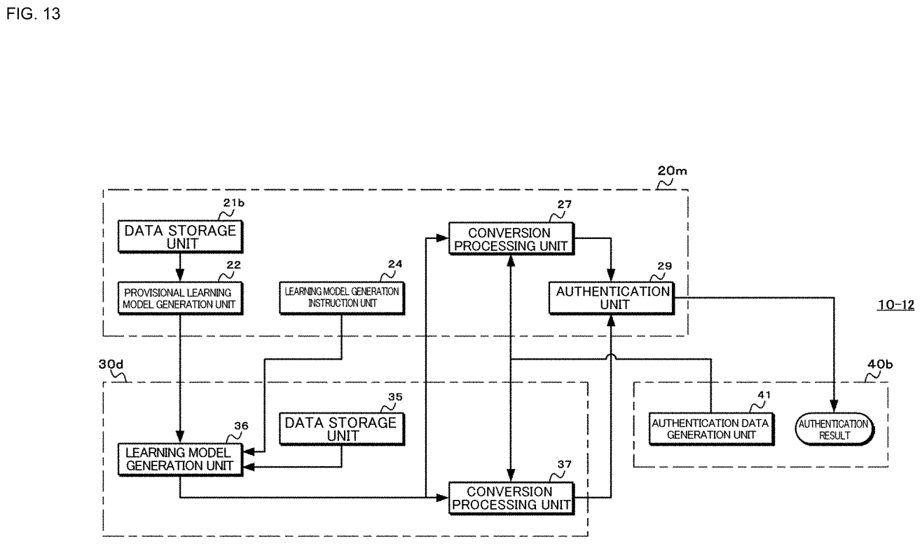

FIG. 13 illustrates a configuration of the twelfth example of the first embodiment. An authentication system 10-12 is configured using an authentication management device 20m, the to-be-authenticated device 30d, and the authentication requesting device 40b.

The authentication management device 20m includes the data storage unit 21b, the provisional learning model generation unit 22, the learning model generation instruction unit 24, the conversion processing unit 27, and the authentication unit

The data storage unit 21b stores provisional learning data used to generate a provisional learning model. The provisional learning data stored in the data storage unit 21b is used to generate a provisional learning model in the provisional learning model generation unit 22.

The provisional learning model generation unit 22 generates a provisional learning model. The provisional learning model generation unit 22 generate the provisional learning model using the provisional learning data stored in the data storage unit 21b. The provisional learning model generation unit 22 outputs the generated provisional learning model to the learning model generation unit 36 of the to-be-authenticated device 30d.

The learning model generation instruction unit 24 instructs the to-be-authenticated device 30d to generate a learning model.

The conversion processing unit 27 acquires the learning model generated by the learning model generation unit 36 of the to-be-authenticated device 30d and inputs authentication data from the authentication requesting device 40b to this learning model to generate authentication conversion data. The conversion processing unit 27 outputs the generated authentication conversion data to the authentication unit 29.

The authentication unit 29 authenticates whether the to-be-authenticated device 30d is an authenticated device on the basis of an identity of the authentication conversion data supplied from the conversion processing unit 27 and the to-be-authenticated side conversion data supplied from the conversion processing unit 37 of the to-be-authenticated device 30d. When the authentication conversion data and the to-be-authenticated side conversion data are identical, the authentication unit 29 generates an authentication result representing that the to-be-authenticated device 30d is an authenticated device and outputs the authentication result to the authentication requesting device 40b.

The to-be-authenticated device 30d includes the data storage unit 35, the learning model generation unit 36, and the conversion processing unit 37.

The data storage unit 35 stores learning data used to generate a learning model, and the learning data is used in the learning model generation unit 36 and the learning model generation unit 26 of the authentication management device 20m as described above.

The learning model generation unit 36 generates a learning model specific to the to-be-authenticated device 30d, which is different from the provisional learning model, using the provisional learning model generated by the provisional learning model generation unit 22 of the authentication management device 20m and the learning data stored in the data storage unit 35 on the basis of an instruction from the learning model generation instruction unit 24 of the authentication management device 20m. The learning model generation unit 36 outputs the generated learning model to the conversion processing unit 37 and the conversion processing unit 27 of the authentication management device 20m.

The conversion processing unit 37 inputs authentication data from the authentication requesting device 40b to the learning model generated by the learning model generation unit 36 to generate to-be-authenticated side conversion data. The conversion processing unit 37 outputs the generated to-be-authenticated side conversion data to the authentication unit 29 of the authentication management device 20m.

The authentication requesting device 40b includes the authentication data generation unit 41. The authentication data generation unit 41 generates authentication data used for authentication and outputs the authentication data to the conversion processing unit 27 of the authentication management device 20m and the conversion processing unit 37 of the to-be-authenticated device 30d.

<2-13. Modified Example of First Embodiment>

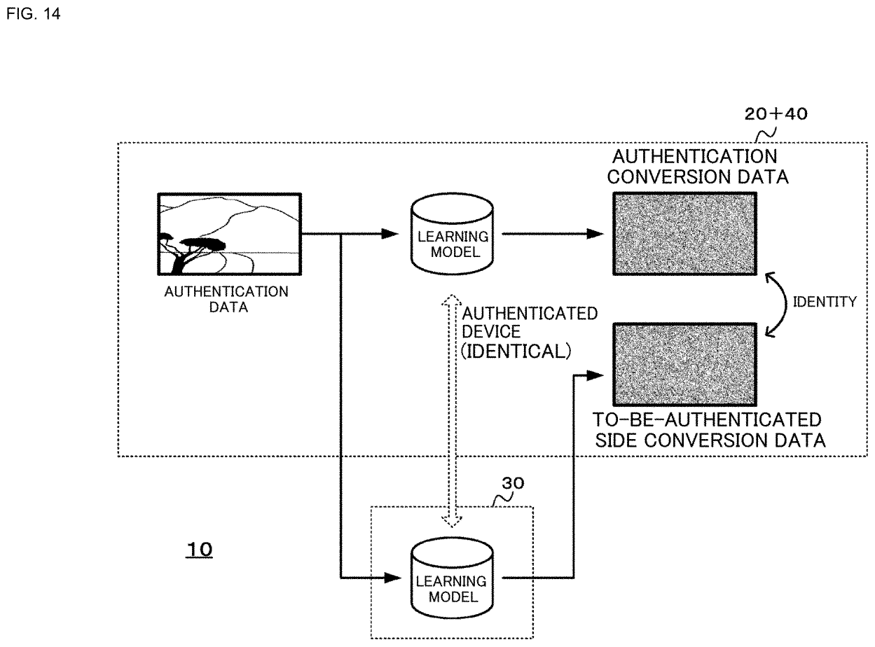

FIG. 14 is a diagram for describing the concept of a modified example of the first embodiment. In the modified example, an authentication management device and an authentication requesting device are consumed to be an identical device.

For example, a case in which an authentication requesting device corresponds to a bank and a to-be-authenticated device corresponds to an account holder holding an account in the bank may be conceived. When the bank performs personal authentication of the account holder, the bank and the account holder can share a learning model in advance because the authentication process may be confined to the inside of the bank. Accordingly, when the bank requests authentication, authentication data designated by the bank is transmitted to a to-be-authenticated person. In addition, the bank inputs the authentication data to the learning model inside the bank to generate authentication conversion data. Further, the bank also acquires to-be-authenticated side conversion data converted by the to-be-authenticated person. Accordingly, as long as the bank itself verifies the identity of the authentication conversion data and the to-be-authenticated side conversion data, the bank can determine whether the to-be-authenticated person is the account holder. Therefore, a configuration of the authentication management device 20 and a configuration of the authentication requesting device 40 may be integrated into the same device in the modified example.

<2-14. With Respect to Case in which to-be-Authenticated Device has not been Authenticated>

In the above-described examples, the to-be-authenticated device is an authenticated device and the same learning model is used in the authentication management device 20 and the to-be-authenticated device 30. However, when the to-be-authenticated device is an unauthenticated device, a learning model generated by the authentication management device 20 is not supplied to the unauthenticated to-be-authenticated device 30, or learning data stored in the unauthenticated to-be-authenticated device 30 and a learning model generated therein are not used in the authentication management device 20. Accordingly, authentication conversion data generated by the authentication management device 20 and to-be-authenticated side conversion data generated by the to-be-authenticated device 30 are not identical, and it is possible to authenticate that the to-be-authenticated device 30 is an unauthenticated device on the basis of an identity of the authentication conversion data and the to-be-authenticated side conversion data.

<2-15. Operation Example of First Embodiment>

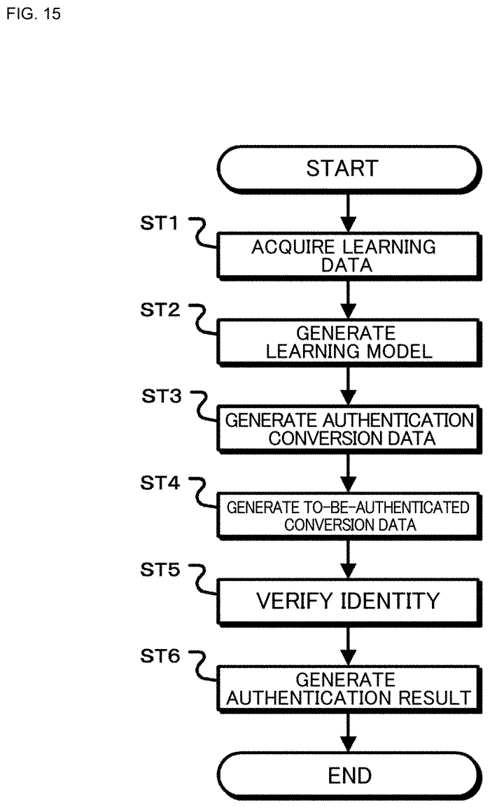

Next, an authentication operation of first embodiment will be described. FIG. 15 is a flowchart illustrating the authentication operation of the first embodiment. In step ST1, an authentication system acquires learning data. The authentication system 10 acquires learning data necessary to generate a learning model and proceeds to step ST2.

In step ST2, the authentication system generates a learning model. The authentication system 10 generates a learning model using the learning data acquired in step ST1 and proceeds to step ST3. Further, generation of the learning model may be performed by any of the authentication management device 20 and the to-be-authenticated device 30.

In step ST3, the authentication system generate authentication conversion data. The authentication management device 20 of the authentication system 10 inputs authentication data to the learning model generated in step ST2 to generate authentication conversion data and proceeds to step ST4.

In step ST4, the authentication system generates to-be-authenticated side conversion data. The to-be-authenticated device 30 of the authentication system 10 inputs the authentication data to the learning model generated in step ST2 to generate to-be-authenticated side conversion data and proceeds to step ST5.

In step ST5, the authentication system verifies the identity of conversion data. The authentication system 10 verifies the identity of the authentication conversion data generated in step ST3 and the to-be-authenticated side conversion data generated in step ST4 and proceeds to step ST6.

In step ST6, the authentication system generates an authentication result. The authentication system 10 determines that the to-be-authenticated device 30 is an authenticated device when the authentication conversion data and the to-be-authenticated side conversion data are identical, determines that the to-be-authenticated device 30 is an unauthenticated device when the authentication conversion data and the to-be-authenticated side conversion data are not identical on the basis of an authentication result of step ST5, and generates an authentication result of the to-be-authenticated device 30. Further, verification of identity in step ST5 and generation of the authentication result in step ST6 may be performed by any of the authentication management device 20 and the authentication requesting device 40.

<2-16. Another Operation Example of First Embodiment>

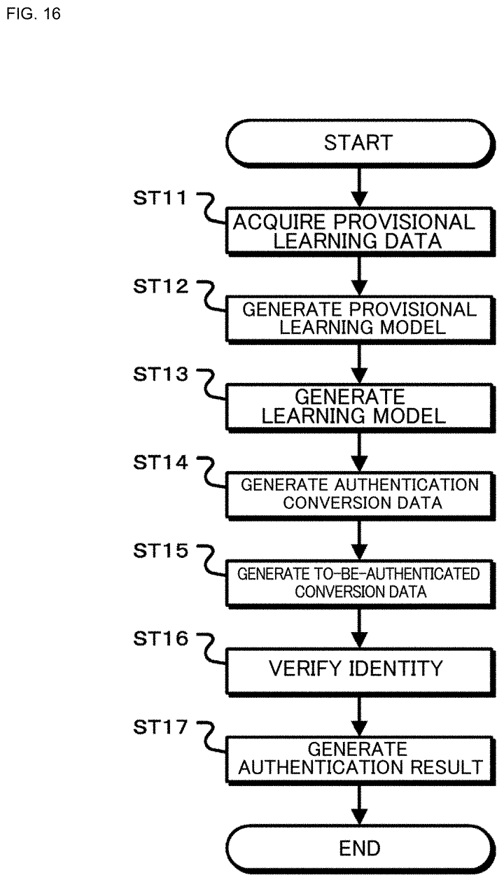

Next, another operation example of the first embodiment will be described. FIG. 16 is a flowchart illustrating another operation example of the first embodiment. In step ST11, an authentication system acquires provisional learning data. The authentication system 10 acquires provisional learning data necessary to generate a provisional learning model and proceeds to step ST12.

In step ST12, the authentication system generates a provisional learning model. The authentication management device 20 of the authentication system 10 generates a provisional learning model using the provisional learning data acquired in step ST11 and proceeds to step ST13.

In step ST13, the authentication system generates a learning model. The authentication system 10 generates a learning model using the provisional learning model generated in step ST12 and learning data stored in the to-be-authenticated device 30 and proceeds to step ST14. Further, a learning model may be generated by the to-be-authenticated device 30, or the learning data stored in the to-be-authenticated device 30 may be output to the authentication management device 20 and the to-be-authenticated device 30 and the authentication management device 20 may generate an identical learning model.

In step ST14, the authentication system generates authentication conversion data. The authentication management device 20 of the authentication system 10 inputs authentication data to the learning model generated in step ST13 to generate authentication conversion data and proceeds to step ST15.

In step ST15, the authentication system generates to-be-authenticated side conversion data. The to-be-authenticated device 30 of the authentication system 10 inputs the authentication data to the learning model generated in step ST13 to generate to-be-authenticated side conversion data and proceeds to step ST16.

In step ST16, the authentication system verifies the identity of conversion data. The authentication system 10 verifies the identity of the authentication conversion data generated in step ST14 and the to-be-authenticated side conversion data generated in step ST15 and proceeds to step ST17.

In step ST17, the authentication system generates an authentication result. The authentication system 10 determines that the to-be-authenticated device 30 is an authenticated device when the authentication conversion data and the to-be-authenticated side conversion data are identical, determines that the to-be-authenticated device 30 is an authenticated device when the authentication conversion data and the to-be-authenticated side conversion data are not identical on the basis of an authentication result of step ST16, and generates an authentication result of the to-be-authenticated device 30. Further, verification of identity in step ST16 and generation of the authentication result in step ST17 may be performed by any of the authentication management device 20 and the authentication requesting device 40.

As described above, it is possible to authenticate whether a to-be-authenticated device is an authenticated device on the basis of identity of authentication conversion data obtained by inputting authentication data supplied from an authentication requesting device to a learning model specific to an authenticated device and to-be-authenticated side conversion data obtained by inputting the authentication data supplied from an authentication requesting device to a learning model of the to-be-authenticated device in the first embodiment.

Further, a learning model of a to-be-authenticated device has leaked to the outside, to-be-authenticated side conversion data that can be generated in an authenticated to-be-authenticated device can also be generated in an unauthenticated to-be-authenticated device. In such a case, the learning model that has leaked may be invalidated and a learning model specific to the authenticated to-be-authenticated device may be newly constructed, and thus replacement is facilitated as in the password method, and information may be easily replaced even if the information leaks without a need for a to-be-authenticated person to remember something to secure authentication accuracy as in the biometric method.

### 3. Second Embodiment

Next, a second embodiment will be described. In the second embodiment, authentication conversion data obtained by inputting authentication data stored in an authenticated to-be-authenticated device to a learning model specific to the to-be-authenticated device is disclosed. In addition, an authentication requesting device performs an authentication instruction for the to-be-authenticated device and acquires to-be-authenticated side conversion data generated by inputting the authentication data stored in the to-be-authenticated device that has received this authentication instruction to a stored learning model. The authentication requesting device authenticates whether the to-be-authenticated device is an authenticated device on the basis of an identity of the disclosed authentication conversion data and the to-be-authenticated side conversion data acquired from the to-be-authenticated device.

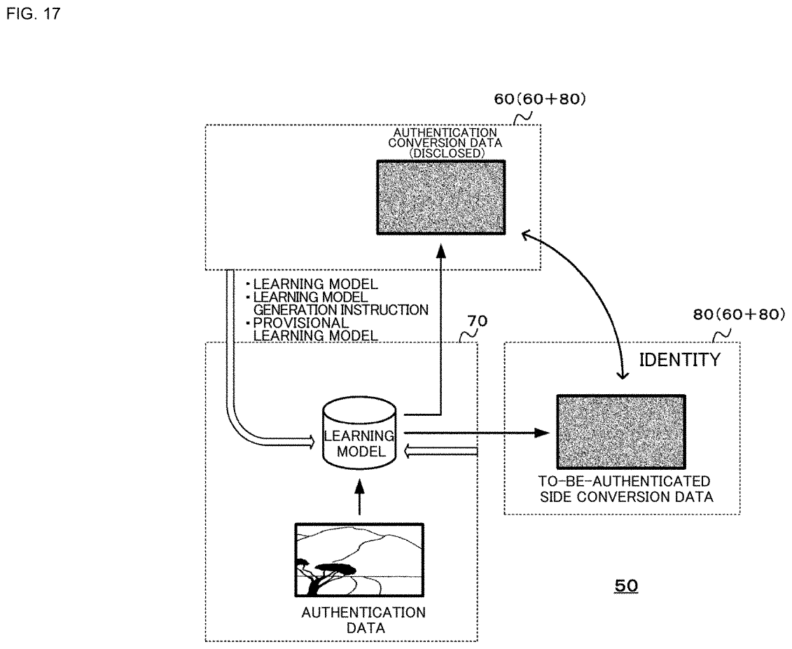

FIG. 17 is a diagram for describing the concept of the second embodiment. The technology of the second embodiment is used when, in a case in which a device 70 of a to-be-authenticated person (to-be-authenticated device) and a device 80 of an authentication requester (authentication requesting device) communicate with each other, the authentication requesting device wants to confirm that the to-be-authenticated device has been authenticated or the authentication requesting device wants to prove that the to-be-authenticated device has been authenticated.

In FIG. 17, the to-be-authenticated device 70 of an authentication system 50 generates and holds a learning model in advance. The learning model is a learning model specific to the to-be-authenticated device which is generated for each to-be-authenticated device. In addition, the to-be-authenticated device 70 designates authentication data to be used for authentication. For example, the authentication data represents an arbitrary image. The authenticated to-be-authenticated device 70 inputs the authentication data to the learning model to generate authentication conversion data that is an inference result. An authentication management device 60 discloses the authentication conversion data. To authenticate that a communication partner is an authenticated device, the authentication requesting device 80 performs an authentication instruction for the to-be-authenticated device 70, and as long as it is possible to confirm that to-be-authenticated side conversion data supplied from the to-be-authenticated device 70 is identical to the disclosed authentication conversion data, it can authenticate that the to-be-authenticated device 70 is an authenticated device because it is possible to prove that the authentication data and the learning model used by the to-be-authenticated device 70 are identical to those when the disclosed authentication conversion data has been generated. Accordingly, authentication accuracy may be secured without a need for a user himself/herself to remember something and authentication may be performed even if authentication information has leaked by easily replacing the information in the second embodiment as in the first embodiment. Next, examples of the second embodiment in a case in which a to-be-authenticated device is an authenticated device will be described. In addition, a case in which a to-be-authenticated device is a device that has not been authenticated will be described thereafter. Further, in the second embodiment, an authentication processing device of the present technology corresponds to an authentication management device, an authentication requesting device, or the authentication management device and the authentication requesting device.

<3-1. First Example of Second Embodiment>

In a first example of the second embodiment, a learning model is generated by the authentication management device. A to-be-authenticated device inputs authentication data stored therein to the learning model generated by the authentication management device to generate authentication conversion data and outputs the authentication conversion data to the authentication management device. The authentication management device discloses the authentication conversion data. The authentication requesting device performs an authentication instruction for the to-be-authenticated device and acquires to-be-authenticated side conversion data generated by the to-be-authenticated device on the basis of the authentication instruction. In addition, the authentication requesting device determines whether the disclosed authentication conversion data and the to-be-authenticated side conversion data generated by the to-be-authenticated device are identical.

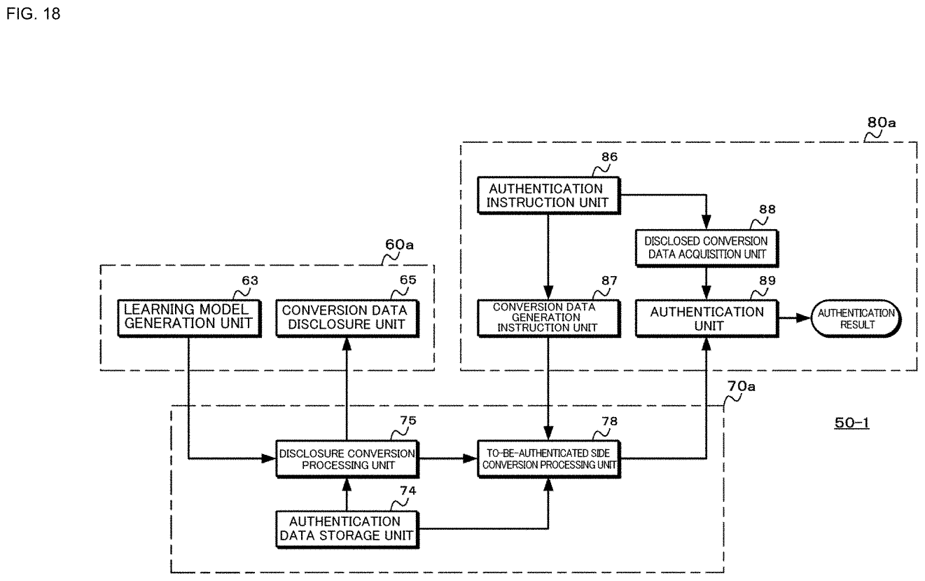

FIG. 18 illustrates a configuration of the first example of the second embodiment. An authentication system 50-1 is configured using an authentication management device 60a, a to-be-authenticated device 70a, and an authentication requesting device 80a.

The authentication management device 60a includes a learning model generation unit 63 and a conversion data disclosure unit 65.

The learning model generation unit 63 generates a learning model. The learning model is not particularly limited as long as it has a sufficiently high degree of freedom (dimensions) of results obtained by learning a large amount of data. An object of the present technology is authentication, it may be guaranteed that a result obtained through conversion processing has been output from a specific learning model, and the output result need not represent an understandable specific meaning, for example. For example, a convolutional neural network (CNN) may be used as the learning model, and a learning model such as ResNet or GoogleNet may be used. The learning model generation unit 63 generates a learning model specific to each authenticated device using learning data of any of the inside and outside of the authentication management device 60a or both thereof. The learning model generation unit 63 outputs the generated learning model to a disclosure conversion processing unit 75 of the to-be-authenticated device 70a. Further, as long as a plurality of pieces of data from different sources are combined and used as the learning data, it is difficult to ascertain which data has been used to generate the learning model and thus security strength can be improved.

The conversion data disclosure unit 65 discloses authentication conversion data supplied from the disclosure conversion processing unit 75 of the to-be-authenticated device 70a. A disclosure destination of the authentication conversion data may be determined according to use. For example, when the authentication conversion data is used for personal authentication necessary for settlement, it is sufficient to disclose the authentication conversion data only to related parties with respect to the settlement.

The to-be-authenticated device 70a includes an authentication data storage unit 74, a disclosure conversion processing unit 75, and a to-be-authenticated side conversion processing unit 78.

The authentication data storage unit 74 stores authentication data used for authentication. The authentication data is data specific to the to-be-authenticated device which is stored in the to-be-authenticated device 70a in advance and can be freely designated as long as it satisfies predetermined specifications. For example, if data used for authentication is images, a degree of freedom (dimensions) of conversion data obtained by a conversion processing unit can be improved by increasing the size, bit depth, and number of images.

The disclosure conversion processing unit 75 inputs the authentication data stored in the authentication data storage unit 74 to a learning model supplied from the authentication management device 60a to generate authentication conversion data that is an inference result. The disclosure conversion processing unit 75 outputs the generated authentication conversion data to the conversion data disclosure unit 65 of the authentication management device 60a. In addition, the disclosure conversion processing unit 75 outputs the learning model to the to-be-authenticated side conversion processing unit 78.

The to-be-authenticated side conversion processing unit 78 inputs the authentication data stored in the authentication data storage unit 74 to the learning model to generate to-be-authenticated side conversion data that is an inference result on the basis of a conversion data generation instruction from a conversion data generation instruction unit 87 of the authentication requesting device 80a. The to-be-authenticated side conversion processing unit 78 outputs the generated to-be-authenticated side conversion data to an authentication unit 89 of the authentication requesting device 80a.

The authentication requesting device 80a includes an authentication instruction unit 86, the conversion data generation instruction unit 87, a disclosed conversion data acquisition unit 88, and the authentication unit 89.

The authentication instruction unit 86 performs an authentication instruction for the conversion data generation instruction unit 87 and the disclosed conversion data acquisition unit 88 according to an authentication request from a user.

The conversion data generation instruction unit 87 performs a conversion data generation instruction for the to-be-authenticated side conversion processing unit 78 of the to-be-authenticated device 70a to cause the to-be-authenticated side conversion processing unit 78 to generate to-be-authenticated side conversion data on the basis of the authentication instruction from the authentication instruction unit 86.

The disclosed conversion data acquisition unit 88 acquires the authentication conversion data on the basis of the authentication instruction from the authentication instruction unit 86 and outputs the acquired authentication conversion data to the authentication unit 89.

The authentication unit 89 acquires the to-be-authenticated side conversion data generated by the to-be-authenticated side conversion processing unit 78 of the to-be-authenticated device 70a on the basis of the authentication instruction and authenticates that the to-be-authenticated device 70a is an authenticated device on the basis of an identity of the acquired to-be-authenticated side conversion data and the authentication conversion data acquired by the disclosed conversion data acquisition unit 88. Here, when the to-be-authenticated device 70a is an authenticated device, the learning model and the authentication data used to generate the authentication conversion data are identical to the learning model and the authentication data used when the to-be-authenticated side conversion data has been generated on the basis of the authentication instruction. Accordingly, when the authentication conversion data and the to-be-authenticated side conversion data are identical, the authentication unit 89 generates an authentication result representing that the to-be-authenticated device 70a is an authenticated device.

<3-2. Second Example of Second Embodiment>

A second example of the second embodiment differs from the first example in that a learning model is generated using learning data stored in an authentication management device.

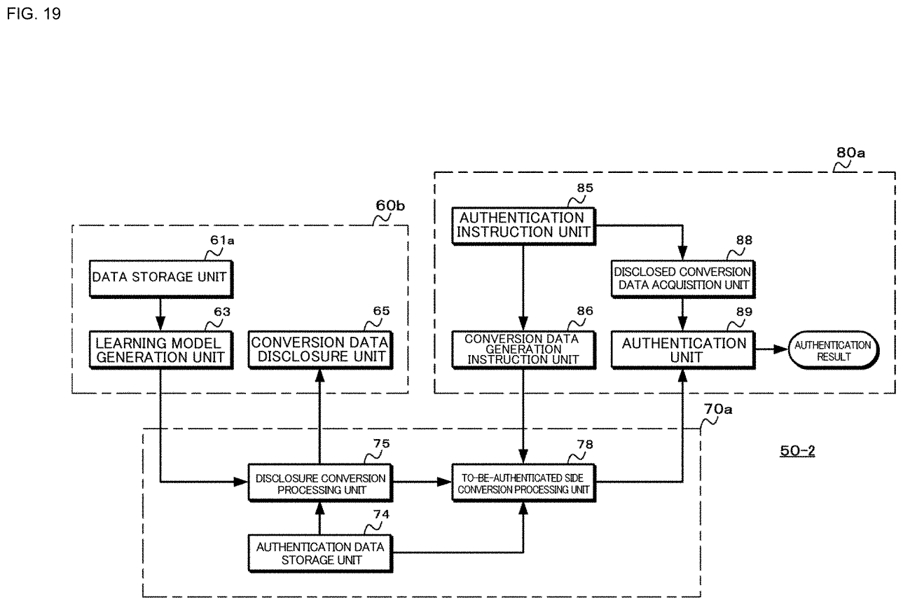

FIG. 19 illustrates a configuration of the second example of the second embodiment. An authentication system 50-2 is configured using an authentication management device 60b, the to-be-authenticated device 70a, and the authentication requesting device 80a.

The authentication management device 60b includes a data storage unit 61a, the learning model generation unit 63, and the conversion data disclosure unit 65.

The data storage unit 61a stores a large amount of learning data used to generate a learning model. The learning model generation unit 63 generates a learning model using the learning data stored in the data storage unit 61a and outputs the learning model to the disclosure conversion processing unit 75 of the to-be-authenticated device 70a. In addition, as long as a plurality of data groups are stored in the data storage unit 61a and pieces of learning data from the plurality of data groups are combined and used, it is difficult to ascertain which data has been used to generate a learning model and thus security strength can be improved.

The conversion data disclosure unit 65 discloses authentication conversion data supplied from the disclosure conversion processing unit 75 of the to-be-authenticated device 70a.

The to-be-authenticated device 70a includes an authentication data storage unit 74, a disclosure conversion processing unit 75, and a to-be-authenticated side conversion processing unit 78.

The authentication data storage unit 74 stores authentication data used for authentication.

The disclosure conversion processing unit 75 inputs the authentication data stored in the authentication data storage unit 74 to the learning model supplied from the authentication management device 60b to generate authentication conversion data that is an inference result. The disclosure conversion processing unit 75 outputs the generated authentication conversion data to the conversion data disclosure unit 65 of the authentication management device 60b. In addition, the disclosure conversion processing unit 75 outputs the learning model to the to-be-authenticated side conversion processing unit 78.

The to-be-authenticated side conversion processing unit 78 inputs the authentication data stored in the authentication data storage unit 74 to the learning model to generate to-be-authenticated side conversion data that is an inference result on the basis of a conversion data generation instruction from a conversion data generation instruction unit 87 of the authentication requesting device 80a. The to-be-authenticated side conversion processing unit 78 outputs the generated to-be-authenticated side conversion data to an authentication unit 89 of the authentication requesting device 80a.

The authentication requesting device 80a includes an authentication instruction unit 86, the conversion data generation instruction unit 87, a disclosed conversion data acquisition unit 88, and the authentication unit 89.

The authentication instruction unit 86 performs an authentication instruction for the conversion data generation instruction unit 87 and the disclosed conversion data acquisition unit 88 according to an authentication request from a user.

The conversion data generation instruction unit 87 performs a conversion data generation instruction for the to-be-authenticated side conversion processing unit 78 of the to-be-authenticated device 70a to cause the to-be-authenticated side conversion processing unit 78 to generate to-be-authenticated side conversion data on the basis of the authentication instruction from the authentication instruction unit 86.

The disclosed conversion data acquisition unit 88 acquires disclosed authentication conversion data and outputs the acquired authentication conversion data to the authentication unit 89 on the basis of the authentication instruction from the authentication instruction unit 86.

The authentication unit 89 acquires the to-be-authenticated side conversion data generated by the to-be-authenticated side conversion processing unit 78 of the to-be-authenticated device 70a on the basis of the authentication instruction and authenticates whether the to-be-authenticated device 70a is an authenticated device on the basis of an identity of the acquired to-be-authenticated side conversion data and the authentication conversion data acquired by the disclosed conversion data acquisition unit 88. When the authentication conversion data and the to-be-authenticated side conversion data are identical, the authentication unit 89 generates an authentication result representing that the to-be-authenticated device 70a is an authenticated device.

<3-3. Third Example of Second Embodiment>

A third example of the second embodiment differs from the above-described examples in that communication of a learning model is not performed between an authentication management device and a to-be-authenticated device to prevent the learning model from leaking. In addition, since generation of a learning model requires high calculation cost, generation of a learning model in the to-be-authenticated device is a considerable burden on the to-be-authenticated device. Accordingly, in the third example, a provisional learning model obtained by performing generation of a learning model halfway in the authentication management device is supplied to the to-be-authenticated device assumed to be an authenticated device, and additional learning (so-called transfer learning) is performed through the provisional learning model using learning data designated by the to-be-authenticated device to reduce calculation cost of the to-be-authenticated device and to generate a learning model specific to the to-be-authenticated device.

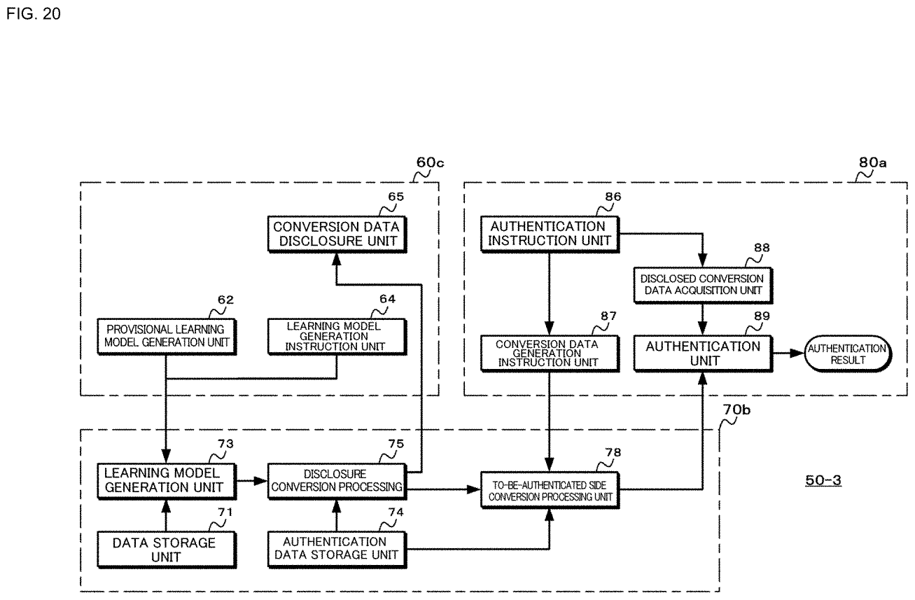

FIG. 20 illustrates a configuration of the third example of the second embodiment. An authentication system 50-3 is configured using an authentication management device 60c, a to-be-authenticated device 70b, and the authentication requesting device 80a.

The authentication management device 60c includes a provisional learning model generation unit 62, a learning model generation instruction unit 64, and the conversion data disclosure unit 65.

The provisional learning model generation unit 62 generates a provisional learning model. The provisional learning model generation unit 62 generates the provisional learning model using learning data of any of the inside and outside of the authentication management device 60c or both thereof. The provisional learning model generation unit 62 outputs the generated provisional learning model to a learning model generation unit 73 of the to-be-authenticated device 70b.

The learning model generation instruction unit 64 instructs the to-be-authenticated device 70b to generate a learning model.

The to-be-authenticated device 70b includes a data storage unit 71, a learning model generation unit 73, the authentication data storage unit 74, the disclosure conversion processing unit 75, and the to-be-authenticated side conversion processing unit 78.

The data storage unit 71 stores learning data used to generate a learning model, and the learning data is used in the learning model generation unit 73.

The learning model generation unit 73 generates a learning model specific to the to-be-authenticated device 70b, which is different from the provisional learning model, using the provisional learning model generated by the provisional learning model generation unit 62 of the authentication management device 60c and the learning data stored in the data storage unit 71 on the basis of an instruction from the learning model generation instruction unit 64 of the authentication management device 60c. The learning model generation unit 73 outputs the generated learning model to the disclosure conversion processing unit 75.

The disclosure conversion processing unit 75 inputs the authentication data stored in the authentication data storage unit 74 to the learning model generated by the learning model generation unit 73 to generate authentication conversion data that is an inference result. The disclosure conversion processing unit 75 outputs the generated authentication conversion data to the conversion data disclosure unit 65 of the authentication management device 60c. In addition, the disclosure conversion processing unit 75 outputs the learning model to the to-be-authenticated side conversion processing unit 78.

The to-be-authenticated side conversion processing unit 78 inputs the authentication data stored in the authentication data storage unit 74 to the learning model to generate to-be-authenticated side conversion data according to a conversion data generation instruction from the conversion data generation instruction unit 87 of the authentication requesting device 80a. The to-be-authenticated side conversion processing unit 78 outputs the generated to-be-authenticated side conversion data to an authentication unit 89 of the authentication requesting device 80a.

The authentication requesting device 80a includes an authentication instruction unit 86, the conversion data generation instruction unit 87, a disclosed conversion data acquisition unit 88, and the authentication unit 89.

The authentication instruction unit 86 performs an authentication instruction for the conversion data generation instruction unit 87 and the disclosed conversion data acquisition unit 88 according to an authentication request from a user.

The conversion data generation instruction unit 87 performs a conversion data generation instruction for the to-be-authenticated side conversion processing unit 78 of the to-be-authenticated device 70b to cause the to-be-authenticated side conversion processing unit 78 to generate to-be-authenticated side conversion data on the basis of the authentication instruction from the authentication instruction unit 86.

The disclosed conversion data acquisition unit 88 acquires disclosed authentication conversion data and outputs the authentication conversion data to the authentication unit 89 on the basis of an authentication instruction from the authentication instruction unit 86.

The authentication unit 89 acquires the to-be-authenticated side conversion data generated by the to-be-authenticated side conversion processing unit 78 of the to-be-authenticated device 70b on the basis of the authentication instruction and authenticates whether the to-be-authenticated device 70b is an authenticated device on the basis of an identity of the acquired to-be-authenticated side conversion data and the authentication conversion data acquired by the disclosed conversion data acquisition unit 88. When the authentication conversion data and the to-be-authenticated side conversion data are identical, the authentication unit 89 generates an authentication result representing that the to-be-authenticated device 70b is an authenticated device.

<3-4. Fourth Example of Second Embodiment>

A fourth example of the second embodiment differs from the third example in that an authentication management device is provided with a data storage unit.

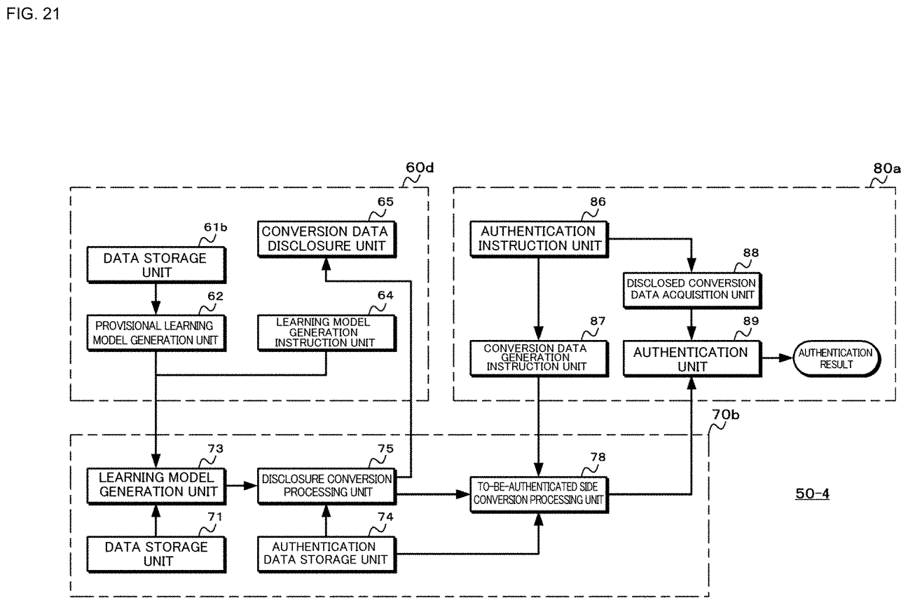

FIG. 21 illustrates a configuration of the fourth example of the second embodiment. An authentication system 50-4 is configured using an authentication management device 60d, the to-be-authenticated device 70b, and the authentication requesting device 80a.

The authentication management device 60d includes a data storage unit 61b, the provisional learning model generation unit 62, the learning model generation instruction unit 64, and the conversion data disclosure unit 65.

The data storage unit 61b stores provisional learning data used to generate a provisional learning model. The provisional learning data stored in the data storage unit 61b is used to generate a provisional learning model in the provisional learning model generation unit 62.

The provisional learning model generation unit 62 generates a provisional learning model. The provisional learning model generation unit 62 generates the provisional learning model using learning data stored in the data storage unit 61b. The provisional learning model generation unit 62 outputs the generated provisional learning model to the learning model generation unit 73 of the to-be-authenticated device 70b.

The learning model generation instruction unit 64 instructs the to-be-authenticated device 70b to generate a learning model.

The to-be-authenticated device 70b includes a data storage unit 71, a learning model generation unit 73, the authentication data storage unit 74, the disclosure conversion processing unit 75, and the to-be-authenticated side conversion processing unit 78.

The data storage unit 71 stores learning data used to generate a learning model, and the learning data is used in the learning model generation unit 73.

The learning model generation unit 73 generates a learning model specific to the to-be-authenticated device 30d which is different from the provisional learning model using the provisional learning model generated by the provisional learning model generation unit 62 of the authentication management device 60d and the learning data stored in the data storage unit 71 according to a learning model generation instruction from the learning model generation instruction unit 64 of the authentication management device 60d. The learning model generation unit 73 outputs the generated learning model to the disclosure conversion processing unit

The disclosure conversion processing unit 75 inputs the authentication data stored in the authentication data storage unit 74 to the learning model generated by the learning model generation unit 73 to generate authentication conversion data that is an inference result. The disclosure conversion processing unit 75 outputs the generated authentication conversion data to the conversion data disclosure unit 65 of the authentication management device 60d. In addition, the disclosure conversion processing unit 75 outputs the learning model to the to-be-authenticated side conversion processing unit 78.

The to-be-authenticated side conversion processing unit 78 inputs the authentication data stored in the authentication data storage unit 74 to the learning model to generate to-be-authenticated side conversion data according to a conversion data generation instruction from the conversion data generation instruction unit 87 of the authentication requesting device 80a. The to-be-authenticated side conversion processing unit 78 outputs the generated to-be-authenticated side conversion data to an authentication unit 89 of the authentication requesting device 80a.

The authentication requesting device 80a includes an authentication instruction unit 86, the conversion data generation instruction unit 87, a disclosed conversion data acquisition unit 88, and the authentication unit 89.

The authentication instruction unit 86 performs an authentication instruction for the conversion data generation instruction unit 87 and the disclosed conversion data acquisition unit 88 according to an authentication request from a user.

The conversion data generation instruction unit 87 performs a conversion data generation instruction for the to-be-authenticated side conversion processing unit 78 of the to-be-authenticated device 70b to cause the to-be-authenticated side conversion processing unit 78 to generate to-be-authenticated side conversion data on the basis of the authentication instruction from the authentication instruction unit 86.

The disclosed conversion data acquisition unit 88 acquires the authentication conversion data on the basis of the authentication instruction from the authentication instruction unit 86 and outputs the acquired authentication conversion data to the authentication unit 89.

The authentication unit 89 acquires the to-be-authenticated side conversion data generated by the to-be-authenticated side conversion processing unit 78 of the to-be-authenticated device 70b on the basis of the authentication instruction and authenticates whether the to-be-authenticated device 70b is an authenticated device on the basis of an identity of the acquired to-be-authenticated side conversion data and the authentication conversion data acquired by the disclosed conversion data acquisition unit 88. When the authentication conversion data and the to-be-authenticated side conversion data are identical, the authentication unit 89 generates an authentication result representing that the to-be-authenticated device 70b is an authenticated device.

<3-5. Fifth Example of Second Embodiment>

Although the above-described first to fourth examples illustrates cases in which an authentication management device and an authentication requesting device are different from each other, the authentication management device and the authentication requesting device may be identical.

A fifth example of the second embodiment illustrates a case in which the authentication management device and the authentication requesting device in the first example are provided as an identical device, for example, a case in which the configuration of the authentication management device is provided in the authentication requesting device.

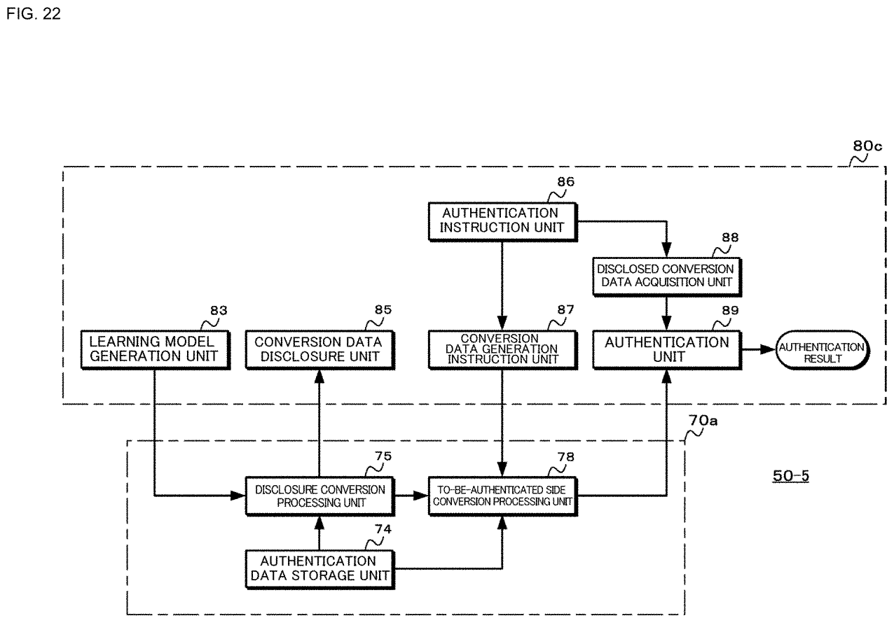

FIG. 22 illustrates a configuration of the fifth example of the second embodiment. An authentication system 50-5 is configured using the to-be-authenticated device 70a and an authentication requesting device 80c.

The authentication requesting device 80c includes a learning model generation unit 83, a conversion data disclosure unit 85, the authentication instruction unit 86, the conversion data generation instruction unit 87, the disclosed conversion data acquisition unit 88, and the authentication unit 89. The learning model generation unit 83 is configured to be the same as the learning model generation unit 63 of the first example, and the conversion data disclosure unit 85 is configured to be the same as the conversion data disclosure unit 65 of the first example.

Accordingly, in the fifth example, an authentication result of the to-be-authenticated device 70a can be obtained by performing the same processing as that in the first example.

<3-6. Sixth Example of Second Embodiment>

A sixth example of the second embodiment illustrates a case in which the authentication management device and the authentication requesting device in the second example are provided as an identical device, for example, a case in which the configuration of the authentication management device is provided in the authentication requesting device.

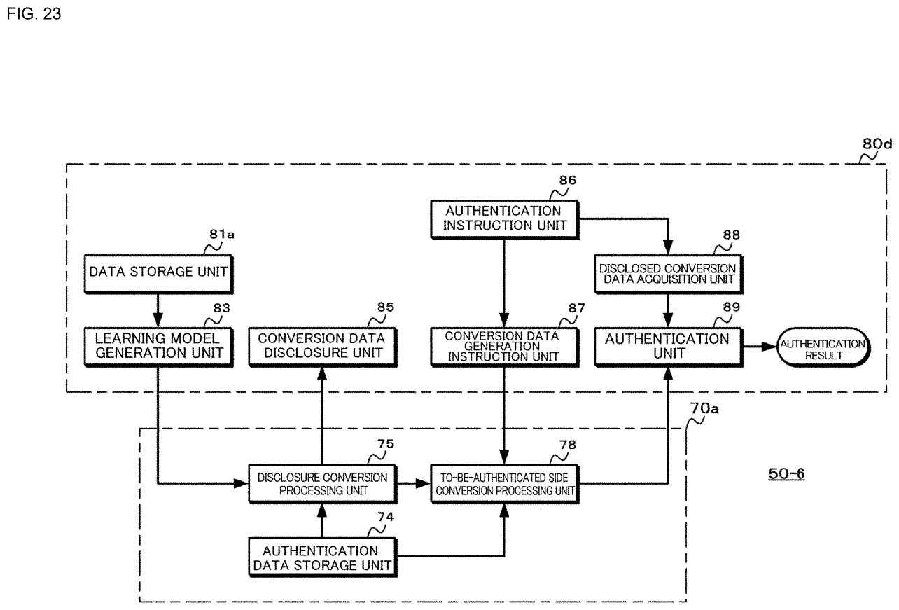

FIG. 23 illustrates a configuration of the sixth example of the second embodiment. An authentication system 50-6 is configured using the to-be-authenticated device 70a and an authentication requesting device 80d.

The authentication requesting device 80d includes a data storage unit 81a, the learning model generation unit 83, the conversion data disclosure unit 85, the authentication instruction unit 86, the conversion data generation instruction unit 87, the disclosed conversion data acquisition unit 88, and the authentication unit 89. The data storage unit 81a is configured to be the same as the data storage unit 61a of the second example. In addition, the learning model generation unit 83 is configured to be the same as the learning model generation unit 63 of the second example, and the conversion data disclosure unit 85 is configured to be the same as the conversion data disclosure unit 65 of the second example.

Accordingly, in the sixth example, an authentication result of the to-be-authenticated device 70a can be obtained by performing the same processing as that in the second example.

<3-7. Seventh Example of Second Embodiment>

A seventh example of the second embodiment illustrates a case in which the authentication management device and the authentication requesting device in the third example are provided as an identical device, for example, a case in which the configuration of the authentication management device is provided in the authentication requesting device.

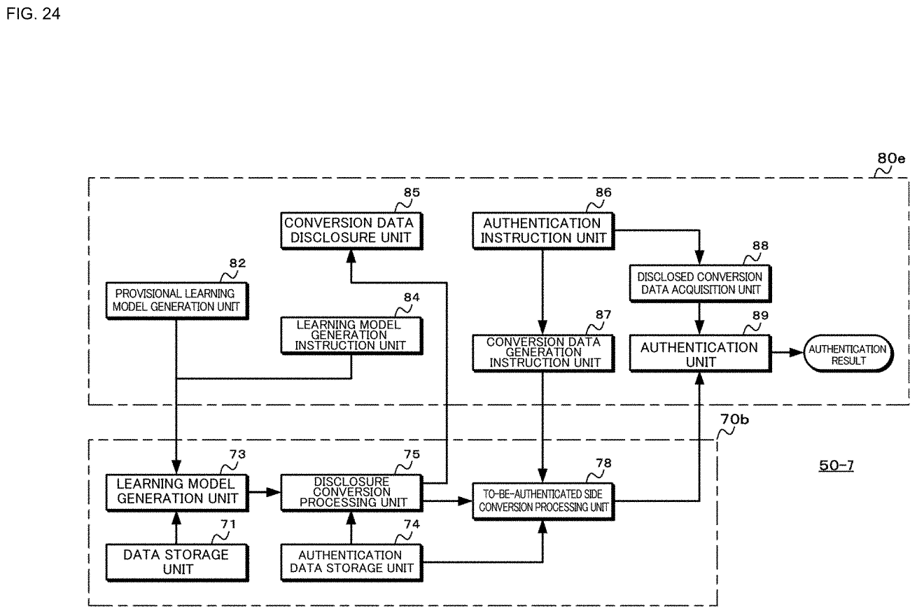

FIG. 24 illustrates a configuration of the seventh example of the second embodiment. An authentication system 50-7 is configured using the to-be-authenticated device 70b and an authentication requesting device 80e.

The authentication requesting device 80e includes a provisional learning model generation unit 82, a learning model generation instruction unit 84, the conversion data disclosure unit 85, the authentication instruction unit 86, the conversion data generation instruction unit 87, the disclosed conversion data acquisition unit 88, and the authentication unit 89.

The provisional learning model generation unit 82 is configured to be the same as the provisional learning model generation unit 62 of the third example, and the learning model generation instruction unit 84 is configured to be the same as the learning model generation instruction unit 64 of the third example. In addition, the conversion data disclosure unit 85 is configured to be the same as the conversion data disclosure unit 65 of the third example.

Accordingly, in the seventh example, an authentication result of the to-be-authenticated device 70b can be obtained by performing the same processing as that in the third example.

<3-8. Eight Example of Second Embodiment>

An eighth example of the second embodiment illustrates a case in which the authentication management device and the authentication requesting device in the fourth example are provided as an identical device, for example, a case in which the configuration of the authentication management device is provided in the authentication requesting device.

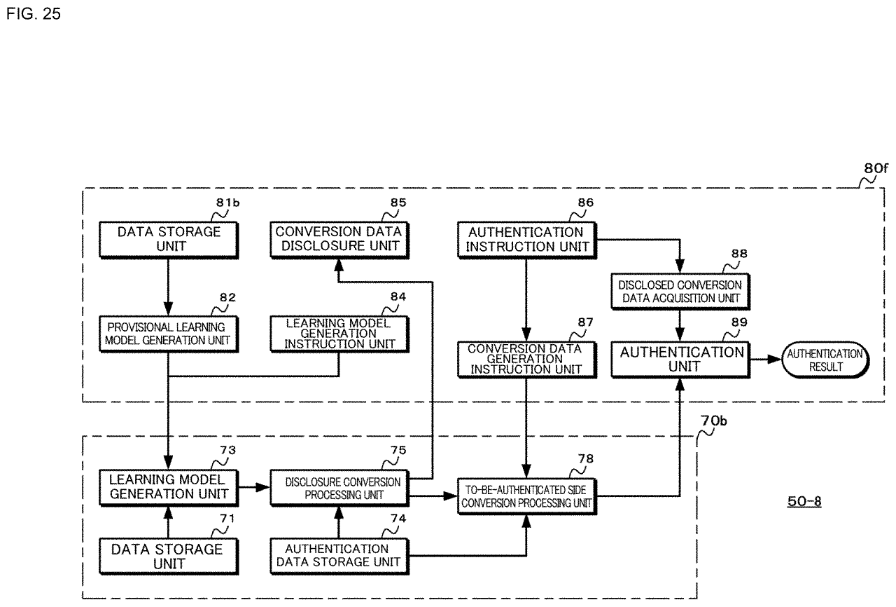

FIG. 25 illustrates a configuration of the eighth example of the second embodiment. An authentication system 50-8 is configured using the to-be-authenticated device 70b and an authentication requesting device 80f.

The authentication requesting device 80f includes a data storage unit 81b, the provisional learning model generation unit 82, the learning model generation instruction unit 84, the conversion data disclosure unit 85, the authentication instruction unit 86, the conversion data generation instruction unit 87, the disclosed conversion data acquisition unit 88, and the authentication unit 89.

The data storage unit 81b is configured to be the same as the data storage unit 61b of the fourth example, and the provisional learning model generation unit 82 is configured to be the same as the provisional learning model generation unit 62 of the fourth example. In addition, the learning model generation instruction unit 84 is configured to be the same as the learning model generation instruction unit 64 of the fourth example, and the conversion data disclosure unit 85 is configured to be the same as the conversion data disclosure unit 65 of the fourth example.

Accordingly, in the eighth example, an authentication result of the to-be-authenticated device 70b can be obtained by performing the same processing as that in the fourth example.

<3-9. With Respect to Case in which to-be-Authenticated Device has not been Authenticated>

In the above-described examples, a to-be-authenticated device is an authenticated device, and an identical learning model and authentication data are used in the to-be-authenticated device 70 at the time of generating to-be-authenticated side conversion data generated on the basis of disclosed authentication conversion data and an authentication instruction. However, a learning model and authentication data used to generate the disclosed authentication conversion data are not used in an unauthenticated to-be-authenticated device. Accordingly, the disclosed authentication conversion data and the to-be-authenticated side conversion data generated by the to-be-authenticated device 70 on the basis of the authentication instruction are not identical, and thus it is possible to authenticate that the to-be-authenticated device 70 is an unauthenticated device.

Further, although the disclosure conversion processing unit 75 that generates authentication conversion data to be disclosed and the to-be-authenticated side conversion processing unit 78 that generates to-be-authenticated side conversion data on the basis of an authentication instruction are individually provided and described in the above-described examples, an identical conversion processing unit may generate the respective pieces of conversion data. That is, when a learning model specific to an authenticated device is supplied, the conversion processing unit generates authentication conversion data using this learning model. Thereafter, the conversion processing unit generates to-be-authenticated side conversion data using the learning model specific to the authenticated device when it receives an authentication instruction (conversion data generation instruction). Accordingly, it is possible to authenticate that a to-be-authenticated device is an authenticated device. In addition, when a learning model specific to an authenticated device is not supplied, the conversion processing unit can determine that a to-be-authenticated device is an unauthenticated device because to-be-authenticated side conversion data is generated without using a learning model specific to the authenticated device.

<3-10. Operation Example of Second Embodiment>

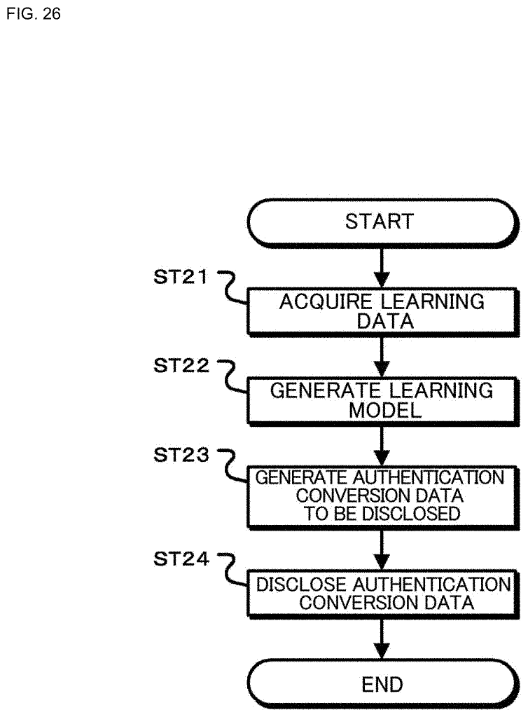

Next, an authentication operation of the second embodiment will be described using a flowchart. FIG. 26 is a flowchart illustrating an operation of disclosing conversion data.

In step ST21, an authentication system acquires learning data. The authentication system 50 acquires learning data necessary to generate a learning model and proceeds to step ST22.

In step ST22, the authentication system generates a learning model. The authentication system 50 generates a learning model using the learning data acquired in step ST21 and proceeds to step ST23. Further, generation of the learning model may be performed by any of the authentication management device 60 and the to-be-authenticated device 70. In addition, when the configuration of the authentication management device 60 is provided in the authentication requesting device 80, operation performed in the authentication management device 60 is performed in the authentication requesting device 80.

In step ST23, the authentication system generates authentication conversion data to be disclosed. The to-be-authenticated device 70 of the authentication system 50 inputs authentication data stored in advance to the learning model generated in step ST21 to generate authentication conversion data to be disclosed and proceeds to step ST24.

In step ST24, the authentication system discloses the authentication conversion data. The authentication management device 60 of the authentication system 50 discloses the authentication conversion data generated in step ST23.

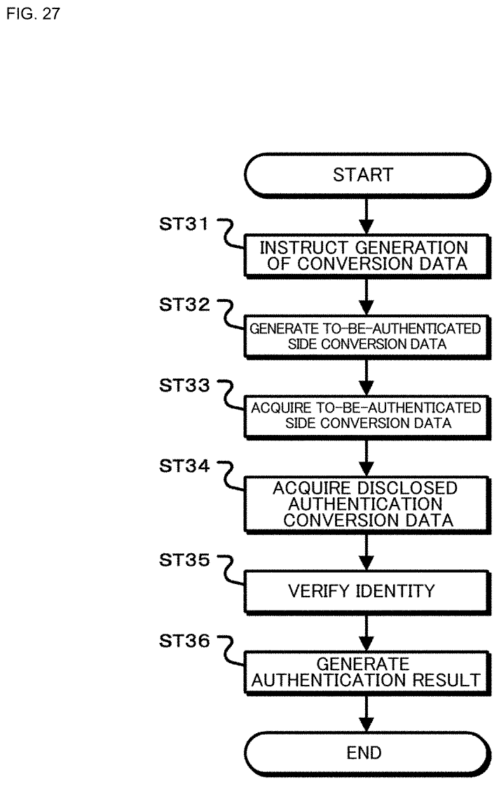

FIG. 27 is a flowchart illustrating an authentication operation using the authentication conversion data.

In step ST31, the authentication system performs conversion data generation instruction. The authentication requesting device 80 of the authentication system 50 performs conversion data generation instruction for the to-be-authenticated device 70 on the basis of an authentication instruction of a user and proceeds to step ST32.

In step ST32, the authentication system generates to-be-authenticated side conversion data. The to-be-authenticated device 70 of the authentication system 50 inputs authentication data stored in advance to a learning model generated in step ST32 to generate to-be-authenticated side conversion data according to the conversion data generation instruction from the authentication requesting device 80 and proceeds to step ST33.

In step ST33, the authentication system acquires the to-be-authenticated side conversion data. The authentication requesting device 80 of the authentication system 50 acquires the to-be-authenticated side conversion data generated in step ST32 and proceeds to step ST34.

In step ST34, the authentication system acquires authentication conversion data to be disclosed. The authentication requesting device 80 of the authentication system 50 acquires the authentication conversion data disclosed in step ST24 of FIG. 26 and proceeds to step ST35.

In step ST35, the authentication system verifies identity of conversion data. The authentication system 50 verifies the identity of the to-be-authenticated side conversion data acquired in step ST33 and the authentication conversion data acquired in step ST34 and proceeds to step ST36.

In step ST36, the authentication system generates an authentication result. The authentication system 10 determines that the to-be-authenticated device 70 is an authenticated device if the to-be-authenticated side conversion data and the authentication conversion data are identical and determines that the to-be-authenticated device 70 is an authenticated device if not on the basis of a verification result of step ST35, and generates an authentication result of the to-be-authenticated device 70.

<3-11. Another Operation Example of Second Embodiment>

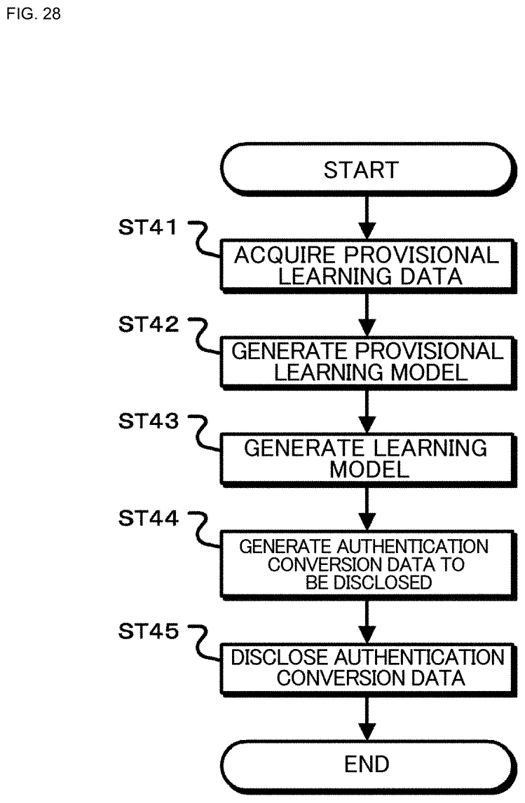

Next, another authentication operation of the second embodiment will be described using a flowchart. FIG. 28 is a flowchart illustrating another operation of disclosing conversion data.

In step ST41, an authentication system acquires provisional learning data. The authentication system 50 acquires learning data necessary to generate a provisional learning model and proceeds to step ST42.

In step ST42, the authentication system generates a provisional learning model. The authentication management device 60 of the authentication system 50 generates a provisional learning model using the provisional learning data acquired in step ST41 and proceeds to step ST43.

In step ST43, the authentication system generates a learning model. The to-be-authenticated device 70 of the authentication system 50 generates a learning model using the provisional learning model generated in step ST42 and learning data stored in advance and proceeds to step ST44.

In step ST44, the authentication system generates authentication conversion data to be disclosed. The to-be-authenticated device 70 of the authentication system 50 inputs authentication data stored in advance to the learning model generated in step ST43 to generate authentication conversion data to be disclosed and proceeds to step ST45.

In step ST45, the authentication system discloses the authentication conversion data. The authentication management device 60 of the authentication system 50 discloses the authentication conversion data generated in step ST44.

As described above, according to the second embodiment, it is possible to authenticate whether a to-be-authenticated device is an authenticated device on the basis of an identity of disclosed authentication conversion data generated by an authenticated to-be-authenticated device and to-be-authenticated side conversion data generated by the to-be-authenticated device that has received an authentication instruction.

Further, when a learning model and authentication data used in an authenticated to-be-authenticated device have leaked to the outside, to-be-authenticated side conversion data that can be generated by only the authenticated to-be-authenticated device can be also be generated by an unauthenticated to-be-authenticated device. In such a case, the learning model and the authentication data that have leaked may be invalidated and a learning model and authentication data specific to the authenticated to-be-authenticated device may be newly constructed, and thus replacement is facilitated as in the password method, and information may be easily replaced even if the information leaks without a need for a to-be-authenticated person to remember something to secure authentication accuracy as in the biometric method.

### 4. Other Embodiments

Although cases in which authentication data is image data have been illustrated in the above-described embodiments, authentication data may be data that can be input to a learning model to obtain an inference result and is not limited to image data. For example, audio data may be used or various types of information data and the like may be used as authentication data.

A series of processes described in the specification can be executed by hardware, software, or a combination thereof. When processes according to software are executed, a program in which a processing sequence is recorded is installed in a memory in a computer incorporated in dedicated hardware and executed. Alternatively, the program may be installed and executed in a general-purpose computer capable of executing various processes.

For example, the program can be recorded in advance in a hard disk, a solid state drive (SSD), or a read only memory (ROM) as a recording medium. Alternatively, the program can be temporarily or permanently stored (recorded) in a removable recording medium such as a flexible disc, a compact disc read only memory (CD-ROM), a magneto optical (MO) disc, a digital versatile disc (DVD), a Blu-ray disc (BD) (registered trademark), a magnetic disk, or a semiconductor memory card. Such a removable recording medium can be provided as so-called package software.

Further, such a program may also be transmitted to a computer from a download site via a network such as a local area network (LAN) or the Internet in a wireless or wired manner instead of being installed in a computer from a removable recording medium. The computer can receive the program transmitted in this manner and install the program in a recording medium such as a built-in hard disk.

The effects described in the present specification are merely illustrative and not restrictive, and other effects that are not described may be obtained. In addition, the present technology is not construed to be limited to the above-described embodiments. The embodiments of the present technology disclose the present technology in illustrative forms, and it will be apparent to those skilled in the art that modification and substitution of the embodiments can be made without departing from the gist of the present technology. That is, the gist of the present technology should be determined in consideration of the claims

The authentication processing device of the present technology can also employ the following configuration.

(1) An authentication processing device including an authentication unit configured to authenticate whether a to-be-authenticated device is an authenticated device on the basis of an identity of authentication conversion data obtained by inputting authentication data to a learning model specific to the authenticated device and to-be-authenticated side conversion data obtained by inputting the authentication data to a learning model of the to-be-authenticated device.

(2) The authentication processing device according to (1), wherein the authentication data is supplied from an authentication requesting device that acquires an authentication result of the authentication unit.

(3) The authentication processing device according to (1) or (2), further including a conversion processing unit configured to input the authentication data to the learning model specific to the authenticated device to generate the authentication conversion data.

(4) The authentication processing device according to (3), further including a learning model generation unit configured to generate the learning model specific to the authenticated device.

(5) The authentication processing device according to (4), further including a provisional learning model generation unit configured to generate a provisional learning model,

wherein the learning model generation unit generates the learning model specific to the authenticated device by performing learning through the provisional learning model generated by the provisional learning model generation unit using learning data stored in the authenticated device.

(6) The authentication processing device according to (3), wherein the conversion processing unit acquires the learning model specific to the authenticated device from the authenticated device.

(7) The authentication processing device according to (6), further including a provisional learning model generation unit configured to generate a provisional learning model,

wherein the conversion processing unit acquires the learning model specific to the authenticated device generated by the authenticated device by performing learning through the provisional learning model generated by the provisional learning model generation unit using learning data stored in the authenticated device.

(8) The authentication processing device according to (1), wherein the authentication conversion data is disclosed data,

wherein the authentication unit authenticates whether the to-be-authenticated device is an authenticated device on the basis of an identity of the disclosed authentication conversion data and the to-be-authenticated side conversion data.

(9) The authentication processing device according to (8), wherein the authentication data is stored in the to-be-authenticated device.

(10) The authentication processing device according to (9), further including a learning model generation unit configured to generate the learning model specific to the authenticated device,

wherein the authentication unit uses conversion data generated by inputting the authentication data stored in the authenticated device to the learning model generated by the learning model generation unit as the authentication conversion data.

(11) The authentication processing device according to (9), further including a provisional learning model generation unit configured to generate a provisional learning model,

wherein the authentication unit generates the learning model specific to the authenticated device by performing learning through the provisional learning model generated by the provisional learning model generation unit using learning data stored in the authenticated device and uses conversion data generated by inputting the authentication data stored in the authenticated device to the generated learning model and disclosed as the authentication conversion data in the authenticated device.

(12) The authentication processing device according to any one of (8) to (11), wherein the authentication unit uses conversion data generated by the to-be-authenticated device as the to-be-authenticated side conversion data according to an authentication instruction.

(13) The authentication processing device according to any one of (1) to (12), further including a data storage unit configured to store learning data used to generate the learning model.

In addition, a to-be-authenticated device of the present technology can also employ the following configuration.

(1) A to-be-authenticated device including a conversion processing unit configured to input authentication data to a learning model to generate to-be-authenticated side conversion data.

(2) The to-be-authenticated device according to (1), wherein the authentication data is supplied from an authentication requesting device that requests authentication.

(3) The to-be-authenticated device according to (1), further including an authentication data storage unit configured to store the authentication data.

(4) The to-be-authenticated device according to (3), further including a disclosure conversion processing unit configured to input the authentication data stored in the authentication data storage unit to the learning model to generate authentication conversion data to be disclosed,

wherein the conversion processing unit inputs the authentication data stored in the authentication data storage unit to the learning model to generate the to-be-authenticated side conversion data on the basis of a conversion data generation instruction from the outside.

(5) The to-be-authenticated device according to any one of (1) to (4), wherein the learning model is acquired from an authentication processing device that performs authentication processing.

(6) The to-be-authenticated device according to any one of (1) to (4), further including a learning model generation unit configured to generate the learning model using learning data supplied from an authentication processing device that performs authentication processing or learning data stored in advance.

(7) The to-be-authenticated device according to any one of (1) to (4), further including a learning model generation unit configured to generate the learning model by performing learning through a provisional learning model generated by an authentication processing device that performs authentication processing using learning data stored in advance.

### REFERENCE SIGNS LIST

10, 10-1 to 10-12, 50, 50-1 to 50-8 Authentication system
20, 20a to 20m Authentication management device
21a, 21b, 31, 35, 61a, 61b, 71, 81a, 81b Data storage unit
22, 62, 82 Provisional learning model generation unit
23, 26, 33, 36, 63, 73, 83 Learning model generation unit
24, 64, 84 Learning model generation instruction unit
27, 37 Conversion processing unit
29, 49, 89 Authentication unit
30, 30a, 30b, 30c, 30d To-be-authenticated device
40, 40a, 40b Authentication requesting device
41 Authentication data generation unit
60, 60a to 60d Authentication management device
65, 85 Conversion data disclosure unit
70, 70a, 70b To-be-authenticated device
74 Authentication data storage unit
75 Disclosure conversion processing unit
78 To-be-authenticated side conversion processing unit
80, 80a, 80b, 80c, 80d, 80e, 80f Authentication requesting device
86 Authentication instruction unit
87 Conversion data generation instruction unit
88 Disclosed conversion data acquisition unit

1. An authentication processing device comprising an authentication unit configured to authenticate whether a to-be-authenticated device is an authenticated device on the basis of an identity of authentication conversion data obtained by inputting authentication data to a learning model specific to the authenticated device and to-be-authenticated side conversion data obtained by inputting the authentication data to a learning model of the to-be-authenticated device.

2. The authentication processing device according to claim 1,
wherein the authentication data is supplied from an authentication requesting device that acquires an authentication result of the authentication unit.

3. The authentication processing device according to claim 1,
further comprising a conversion processing unit configured to input the authentication data to the learning model specific to the authenticated device to generate the authentication conversion data.

4. The authentication processing device according to claim 3,
further comprising a learning model generation unit configured to generate the learning model specific to the authenticated device.

5. The authentication processing device according to claim 4,
further comprising a provisional learning model generation unit configured to generate a provisional learning model,
wherein the learning model generation unit generates the learning model specific to the authenticated device by performing learning through the provisional learning model generated by the provisional learning model generation unit using learning data stored in the authenticated device.

6. The authentication processing device according to claim 3,
wherein the conversion processing unit acquires the learning model specific to the authenticated device from the authenticated device.

7. The authentication processing device according to claim 6,
further comprising a provisional learning model generation unit configured to generate a provisional learning model,
wherein the conversion processing unit acquires the learning model specific to the authenticated device generated by the authenticated device by performing learning through the provisional learning model generated by the provisional learning model generation unit using learning data stored in the authenticated device.

8. The authentication processing device according to claim 1,
wherein the authentication conversion data is disclosed data,
wherein the authentication unit authenticates whether the to-be-authenticated device is an authenticated device on the basis of an identity of the disclosed authentication conversion data and the to-be-authenticated side conversion data.

9. The authentication processing device according to claim 8,
wherein the authentication data is stored in the to-be-authenticated device.

10. The authentication processing device according to claim 9,
further comprising a learning model generation unit configured to generate the learning model specific to the authenticated device,
wherein the authentication unit uses conversion data generated by inputting the authentication data stored in the authenticated device to the learning model generated by the learning model generation unit as the authentication conversion data.

11. The authentication processing device according to claim 9,
further comprising a provisional learning model generation unit configured to generate a provisional learning model,
wherein the authentication unit generates the learning model specific to the authenticated device by performing learning through the provisional learning model generated by the provisional learning model generation unit using learning data stored in the authenticated device and uses conversion data generated by inputting the authentication data stored in the authenticated device to the generated learning model and disclosed as the authentication conversion data in the authenticated device.

12. The authentication processing device according to claim 9,
wherein the authentication unit uses conversion data generated by the to-be-authenticated device as the to-be-authenticated side conversion data according to an authentication instruction.

13. The authentication processing device according to claim 1,
further comprising a data storage unit configured to store learning data used to generate the learning model.

14. An authentication processing method comprising, by an authentication unit, authenticating whether a to-be-authenticated device is an authenticated device on the basis of an identity of authentication conversion data generated by inputting authentication data to a learning model specific to the authenticated device and to-be-authenticated side conversion data obtained by inputting the authentication data to a learning model of the to-be-authenticated device.

15. A to-be-authenticated device comprising
a conversion processing unit configured to input authentication data to a learning model to generate to-be-authenticated side conversion data.

16. The to-be-authenticated device according to claim 15,
wherein the authentication data is supplied from an authentication requesting device that requests authentication.

17. The to-be-authenticated device according to claim 15,
further comprising an authentication data storage unit configured to store the authentication data.

18. The to-be-authenticated device according to claim 17,
comprising a disclosure conversion processing unit configured to input the authentication data stored in the authentication data storage unit to the learning model to generate authentication conversion data to be disclosed,
wherein the conversion processing unit inputs the authentication data stored in the authentication data storage unit to the learning model to generate the to-be-authenticated side conversion data on the basis of a conversion data generation instruction from the outside.

19. The to-be-authenticated device according to claim 15,
wherein the learning model is acquired from an authentication processing device that performs authentication processing.

20. The to-be-authenticated device according to claim 15,
further comprising a learning model generation unit configured to generate the learning model using learning data supplied from an authentication processing device that performs authentication processing or learning data stored in advance.

21. The to-be-authenticated device according to claim 15,
further comprising a learning model generation unit configured to generate the learning model by performing learning through a provisional learning model generated by an authentication processing device that performs authentication processing using learning data stored in advance.

22. An information generation method comprising, by a conversion processing unit, inputting authentication data to a learning model to generate to-be-authenticated side conversion data.
